SEQUENCE LISTING (8 sequences)

SEQ ID NO: 1 - protein, 269 aa, Thermomyces lanuginosus [sequence omitted]

SEQ ID NO: 2 - protein, 544 aa, Geotrichum candidum
QAPTAVLNGNEVISGVLEGKVDTFKGIPFADPPVGDLRFKHPQPFTGSYQGLKANDFSSACMQLDPGNAISLLDKVVGLGKIIPDNLRGPLYDMAQGSVSMNEDCLYLNVFRPAGTKPDAKLPVMVWIYGGAFVFGSSASYPGNGYVKESVEMGQPVVFVSINYRTGPYGFLGGDAITAEGNTNAGLHDQRKGLEWVSDNIANFGGDPDKVMIFGESAGAMSVAHQLVAYGGDNTYNGKQLFHSAILQSGGPLPYFDSTSVGPESAYSRFAQYAGCDASAGDNETLACLRSKSSDVLHSAQNSYDLKDLFGLLPQFLGFGPRPDGNIIPDAAYELYRSGRYAKVPYITGNQEDEGTILAPVAINATTTPHVKKWLKYICSEASDASLDRVLSLYPGSWSEGAPFRTGILNALTPQFKRIAAIFTDLLFQSPRRVMLNATKDVNRWTYLATQLHNLVPFLGTFHGSDLLFQYYVDLGPSSAYRRYFISFANHHDPNVGTNLKQWDMYTDAGREMLQIHMIGNSMRTDDFRIEGISNFESDVTLFG

SEQ ID NO: 3 - protein, 544 aa, Geotrichum candidum
QAPTAVLNGNEVISGVLEGKVDTFKGIPFADPPVGDLRFKHPQPFTGSYQGLKANDFSSACMQLDPGNAISLLDKVVGLGKIIPDNLRGPLYDMAQGSVSMNEDCLYLNVFRPAGTKPDAKLPVMVWIYGGAFVFGSSASYPGNGYVKESVEMGQPVVFVSINYRTGPYGFLGGDAITAEGNTNAGLHDQRKGLEWVSDNIANFGGDPDKVMIFGESAGAMSVAHQLVAYGGDNTYNGKQLFHSAILQSGGPLPYFDSTSVGPESAYSRFAQYAGCDASAGDNETLACLRSKSSDVLHSAQNSYDLKDLFGLLPQFLGFGPRPDGNIIPDAAYELYRSGRYAKVPYITGNQEDEGTILAPVAINATTTPHVKKWLKYICSEASDASLDRVLSLYPGSWSEGAPFRTGILNALTPQFKRIAAIFTDLLFQSPRRVMLNATKDVNRWTYLATQLHNLVPFLGTFHGSDLLFQYYVDLGPSSAYRRYFISFANHHDPNVGTNLKQWDMYTDSGKEMLQIHMIGNSMRTDDFRIEGISNFESDVTLFG

SEQ ID NO: 4 - protein, 544 aa, Geotrichum candidum
QAPTAVLNGNEVISGVLEGKVDTFKGIPFADPPVGDLRFKHPQPFTGSYQGLKANDFSSACMQLDPGNAISLLDKVVGLGKIIPDNLRGPLYDMAQGSVSMNEDCLYLNVFRPAGTKPDAKLPVMVWIYGGAFVFGSSASYPGNGYVKESVEMGQPVVFVSINYRTGPYGFLGGDAITAEGNTNAGLHDQRKGLEWVSDNIANFGGDPDKVMIFGESAGAMSVAHQLVAYGGDNTYNGKQLFHSAILQSGGPLPYFDSTSVGPESAYSRFAQYAGCDASAGDNETLACLRSKSSDVLHSAQNSYDLKDLFGLLPQFLGFGPRPDGNIIPDAAYELYRSGRYAKVPYITGNQEDEGTILAPVAINATTTPHVKKWLKYICSEASDASLDRVLSLYPGSWSEGAPFRTGILNALTPQFKRIAAIFTDLLFQSPRRVMLNATKDVNRWTYLATQLHNLVPFLGTFHGSDLLFQYYVDLGPSSAYRRYFISFANHHDPNVGTNLKQWDMYTDSGKEMLQIHMIGNSMRTDDFRIEGISNFETDVNLYG

SEQ ID NO: 5 - protein, 544 aa, Geotrichum candidum
QAPTAVLNGNEVISGVLEGKVDTFKGIPFADPPVGDLRFKHPQPFTGSYQGLKANDFSSACMQLDPGNAISLLDKVVGLGKIIPDNLRGPLYDMAQGSVSMNEDCLYLNVFRPAGTKPDAKLPVMVWIYGGAFVFGSSASYPGNGYVKESVEMGQPVVFVSINYRTGPYGFLGGDAITAEGNTNAGLHDQRKGLEWVSDNIANFGGDPDKVMIFGESAGAMSVAHQLVAYGGDNTYNGKQLFHSAILQSGGPLPYFDSTSVGPESAYSRFAQYAGCDASAGDNETLACLRSKSSDVLHSAQNSYDLKDLFGLLPQFLGFGPRPDGNIIPDAAYELYRSGRYAKVPYITGNQEDEGTILAPVAINATTTPHVKKWLKYICSEASDASLDRVLSLYPGSWSEGAPFRTGILNALTPQFKRIAAIFTDLLFQSPRRVMLNATKDVNRWTYLATQLHNLVPFLGTFHGSDLLFQYYVDLGPSSAYRRYFISFANHHDPNVGTNLKQWDMYTDSGKEMLQIHMIGNSMRTDDFRIEGISNFESDVNLYG

SEQ ID NO: 6 - protein, 544 aa, Geotrichum candidum
QAPTAVLNGNEVISGVLEGKVDTFKGIPFADPPVGDLRFKHPQPFTGSYQGLKANDFSSACMQLDPGNAFSLLDKVVGLGKILPDNLRGPLYDMAQGSVSMNEDCLYLNVFRPAGTKPDAKLPVMVWIYGGAFVFGSSASYPGNGYVKESVEMGQPVVFVSINYRTGPYGFLGGDAITAEGNTNAGLHDQRKGLEWVSDNIANFGGDPDKVMIFGESAGAMSVAHQLVAYGGDNTYNGKQLFHSAILQSGGPLPYFDSTSVGPESAYSRFAQYAGCDTSASDNDTLACLRSKSSDVLHSAQNSYDLKDLFGLLPQFLGFGPRPDGNIIPDAAYELYRSGRYAKVPYITGNQEDEGTILAPVAINATTTPHVKKWLKYICSQASDASLDRVLSLYPGSWSEGSPFRTGILNALTPQFKRIAAIFTDLLFQSPRRVMLNATKDVNRWTYLATQLHNLVPFLGTFHGSDLLFQYYVDLGPSSAYRRYFISFANHHDPNVGTNLQQWDMYTDAGKEMLQIHMIGNSMRTDDFRIEGISNFESDVTLFG

SEQ ID NO: 7 - protein, 269 aa, synthetic construct
AQSVPWGIRRVQAPTAHNRGLTGSGVKVAVLDTGISTHPDLNIRGGASFVPGEPSTQDGNGHGTHAAGTIAALNNSIGVLGVAPSAELYAVKVLGASGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNVQSTYPGSTYASLDGTSMATPHVAGAAALVKQKNPSWSNVRIRNHLKNTATSLGSTNLYGSGLVNAEAATR

SEQ ID NO: 8 - protein, 483 aa, synthetic construct
HHNGTNGTLMQYFEWYLPNDGNHWNRLRSDASNLKDKGISAVWIPPAWKGASQNDVGYGAYDLYDLGEFNQKGTIRTKYGTRNQLQAAVNALKSNGIQVYGDVVMNHKGGADATEMVKAVEVNPNNRNQEVSGEYTIEAWTKFDFPGRANTHSNFKWRWYHFDGVDWDQSRKLNNRIYKFRTKAWDWEVDTEFGNYDYLLYADIDMDHPEVVNELRNWGVWYTNTLGLDGFRIDAVKHIKYSFTRDWINHVRSAIGKNMFAVAEFWKNDLGAIENYLNKTNWNHSVFDVPLHFNLYYASKSGGNYDMRQIFNGTVVQKHPTHAVTFVDNHDSQPEESLESFVREWFKPLAYALTLTREQGYPSVFYGDYYGIPTHGVPAMKSKIDPILEARQKYAYGRQNDYLDHHNIIGWTREGNTAHPNSGLATIMSDGAGGNKWMFVGRNKAGQVWTDITGNKAGTVTINADGWGNFSVNGGSVSIWVNK

(19) United States
(12) Patent Application Publication
(10) Pub. No.: US 2026/0327522 A1
(43) Pub. Date: Oct. 22, 2026

(54) Automatic Dishwashing Detergent Compositions Comprising a Lipase

(71) Applicant: NOVOZYMES A/S, Bagsvaerd (DK)

(72) Inventor: Katrine THYGESEN, Taastrup (DK)

(73) Assignee: NOVOZYMES A/S, Bagsvaerd (DK)

(21) Appl. No.: 19/481,082

(22) PCT Filed: May 8, 2024
(86) PCT No.: PCT/EP2024/062804

§ 371 Date: Nov. 3, 2025

(30) Foreign Application Priority Data
May 11, 2023 (EP) 23172743.9
Aug. 11, 2023 (EP) 23191050.6

(51) Int. Cl. C11D 3/386

(52) U.S. Cl. CPC C11D 3/38627

(57) ABSTRACT

The present invention relates to automatic dishwashing detergent composition comprising a lipase, methods of cleaning dishware/tableware, and the like, in an automatic dishwasher using an automatic dishwashing detergent composition of the invention. Finally, the invention relates the use of an automatic dishwashing detergent composition of the invention for cleaning dishware/tableware, and the like, in an automatic dishwasher.

### REFERENCE TO A SEQUENCE LISTING

This application contains a Sequence Listing in computer readable form, which is incorporated herein by reference.

### FIELD OF THE INVENTION

The present invention relates to automatic dishwashing detergent compositions (ADW compositions), methods of cleaning dishware/tableware, or the like, in an automatic dishwasher using an automatic dishwashing detergent composition of the invention, and to the use of automatic dishwashing detergent compositions of the invention for cleaning dishware/tableware, and the like, in an automatic dishwasher.

### BACKGROUND OF THE INVENTION

Automatic dishwashing detergent (ADW) compositions have been available to the consumer for decades and have been improved over the years. There has been a trend towards safer and more sustainable and environmentally friendly automatic dishwashing detergent compositions in terms of efficiency at low temperatures and reduction of the amount of, e.g., poorly biodegradable chemicals and chemicals from non-renewable sources. Most commercially available automatic dishwashing detergent (ADW) compositions contain amylase and/or protease which degrades and remove starchy and proteineous matter, respectively. Commercial automatic dishwashing detergent (ADW) compositions also contain surfactants which remove fatty stains to some degree. However, more efficient fat removal is desired.

EP 2,200,949A1 concerns automatic dishwashing detergent (ADW) compositions comprising a new enzymatic system comprising an improved enzymatic system comprising an improved protease variant in combination with a low temperature amylase.

There are still consumer needs which are not met in terms of automatic dishwash cleaning. One unmet problem is that some fat stays on the surface of dishware/tableware, and the like, after the automatic dishwashing process. The object of the present invention is to solve this and related problems.

### SUMMARY OF THE INVENTION

The present invention relates to automatic dishwashing detergent compositions (ADW compositions) capable of at least reducing the amount of fat on the surface of dishware/tableware, e.g., glass, ceramic, plastic and metal dishware/tableware, or the like, after cleaning in an automatic dishwasher.

The inventor of the present invention found that lipases reduce the amount of fat on the surface of dishware/tableware after cleaning in an automatic dishwashing machine (commonly referred to as a “dishwasher”). Particularly good results were obtained when the pH in the washing liquor in the main washing step was between 7.5-10.5 and the temperature was between 40-60 °C. It was also found that certain Thermomyces lanuginosa lipase (TLL) variants increased fat removal compared to the wild-type Thermomyces lanuginose lipase (i.e., SEQ ID NO: 1). Further, GCL1 lipase (i.e., SEQ ID NO: 2) and variants thereof provided increased fat removal compared to Thermomyces lanuginosa lipases. Additionally, the inventor surprisingly found that some slimy fatty acid salt residues remained on the surface of the dishware/tableware and dishwasher's filter after cleaning when using Thermomyces lanuginosa lipases. However, the problem was reduced with certain Thermomyces lanuginosa lipase variants and in particular when using the GCL1 lipase and variants thereof. It was also surprisingly found that GCL1 lipases resulted in increased fat removal and reduced slimy fatty acid salt residues on washed dishware/tableware surfaces. The GCL1 lipases were also surprisingly found to generate less malodors after dishwashing compared to when using Thermomyces lanuginose lipases.

Thus, in the first aspect, the invention relates to automatic dishwashing detergent compositions (ADW compositions) comprising a lipase.

In a second aspect, the invention relates to a method of cleaning dishware/tableware, and the like, in an automatic dishwasher, comprising carrying out a washing step of subjecting the dishware/tableware, and the like, to a wash liquor comprising a composition of the invention. The dishware/tableware, and the like, is subjected to/contacted with the wash liquor comprising a composition of the invention during a main wash step. In a preferred embodiment the pH in the washing liquor is between 7-12, preferably 7.5-10.5, such as 8-10, and the (in-wash) temperature is between 30-70 °C, preferably 40-60 °C, especially around 45 °C or around 55 °C. In an embodiment, 0.01-10 ppm, preferably 0.05-5 ppm, in particular around 0.2 ppm lipase is present in the washing liquor during the main wash step. After the main wash step, the dishware/tableware, and the like, is rinsed and optionally dried at elevated temperature, such as 30-70 °C, in particular around 60 °C.

In a final aspect, the invention relates to the use of an automatic dishwashing detergent composition of the invention for cleaning dishware/tableware, and the like, in an automatic dishwasher.

### BRIEF DESCRIPTION OF THE DRAWINGS

FIG. 1 is a photo showing the test results from Example 2 where the model wash system, Mini Launder-O-Meter (Mini LOM), is used at 45 °C, pH 7.5 using liquid Model Detergent GLDA. Tube 1: Blank, Tube 2: Lipase TLL-A, Tube 3: Lipase GCL1-A.

FIG. 2 shows the filter of a Miele dishwasher with fatty acid salt residues deposited thereon after washing with a detergent composition comprising either no lipase, Lipase TLL-A or Lipase GCL1-A.

### SEQUENCES

SEQ ID NO: 1 is the wild-type Thermomyces lanuginosus lipase (“TLL”)
EVSQDLENQF NLFAQYSAAA YCGKNNDAPA GTNITCTGNA CPEVEKADAT FLYSFEDSGV
GDVTGFLALD NTNKLIVLSF RGSRSIENWI GNLNFDLKEI NDICSGCRGH DGFTSSWRSV
ADTLRQKVED AVREHPDYRV VFTGHSLGGA LATVAGADLR GNGYDIDVES YGAPRVGNRA
FAEFLTVQTG GTLYRITHTN DIVPRLPPRE FGYSHSSPEY WIKSGTLVPV TRNDIVKIEG
IDATGGNNQP NIPDIPAHLW YFGLIGTCL
SEQ ID NO: 2 is a lipase derived from Geotrichum candidum (“GCL 1”)
QAPTAVLNGN EVISGVLEGK VDTFKGIPFA DPPVGDLRFK HPQPFTGSYQ GLKANDESSA
CMQLDPGNAI SLLDKVVGLG KIIPDNLRGP LYDMAQGSVS MNEDCLYLNV FRPAGTKPDA
KLPVMVWIYG GAFVEGSSAS YPGNGYVKES VEMGQPVVFV SINYRTGPYG ELGGDAITAE
GNTNAGLHDQ RKGLEWVSDN IANFGGDPDK VMIFGESAGA MSVAHQLVAY GGDNTYNGKQ
LFHSAILQSG GPLPYFDSTS VGPESAYSRE AQYAGCDASA GDNETLACLR SKSSDVLHSA
QNSYDLKDLF GLLPQFLGFG PRPDGNIIPD AAYELYRSGR YAKVPYITGN QEDEGTILAP
VAINATTTPH VKKWLKYICS EASDASLDRV LSLYPGSWSE GAPFRTGILN ALTPQFKRIA
AIFTDLLFQS PRRVMLNATK DVNRWTYLAT QLHNLVPFLG TFHGSDLLFQ YYVDLGPSSA
YRRYFISFAN HHDPNVGTNL KQWDMYTDAG REMLQIHMIG NSMRTDDERI EGISNFESDV
TLFG
SEQ ID NO: 3 is a lipase derived from Geotrichum candidum
QAPTAVLNGN EVISGVLEGK VDTFKGIPFA DPPVGDLRFK HPQPFTGSYQ GLKANDESSA
CMQLDPGNAI SLLDKVVGLG KIIPDNLRGP LYDMAQGSVS MNEDCLYLNV FRPAGTKPDA
KLPVMVWIYG GAFVFGSSAS YPGNGYVKES VEMGQPVVFV SINYRTGPYG ELGGDAITAE
GNTNAGLHDQ RKGLEWVSDN IANFGGDPDK VMIFGESAGA MSVAHQLVAY GGDNTYNGKQ
LFHSAILQSG GPLPYFDSTS VGPESAYSRE AQYAGCDASA GDNETLACLR SKSSDVLHSA
QNSYDLKDLE GLLPQFLGFG PRPDGNIIPD AAYELYRSGR YAKVPYITGN QEDEGTILAP
VAINATTTPH VKKWLKYICS EASDASLDRV LSLYPGSWSE GAPFRTGILN ALTPQFKRIA
AIFTDLLFQS PRRVMLNATK DVNRWTYLAT QLHNLVPFLG TFHGSDLLFQ YYVDLGPSSA
YRRYFISFAN HHDPNVGTNL KQWDMYTDSG KEMLQIHMIG NSMRTDDERI EGISNFESDV
TLFG
SEQ ID NO: 4 is a lipase derived from Geotrichum candidum
QAPTAVLNGN EVISGVLEGK VDTFKGIPFA DPPVGDLRFK HPQPFTGSYQ GLKANDESSA
CMQLDPGNAI SLLDKVVGLG KIIPDNLRGP LYDMAQGSVS MNEDCLYLNV FRPAGTKPDA
KLPVMVWIYG GAFVFGSSAS YPGNGYVKES VEMGQPVVFV SINYRTGPYG FLGGDAITAE
GNTNAGLHDQ RKGLEWVSDN IANFGGDPDK VMIFGESAGA MSVAHQLVAY GGDNTYNGKQ
LFHSAILQSG GPLPYFDSTS VGPESAYSRF AQYAGCDASA GDNETLACLR SKSSDVLHSA
QNSYDLKDLF GLLPQFLGFG PRPDGNIIPD AAYELYRSGR YAKVPYITGN QEDEGTILAP
VAINATTTPH VKKWLKYICS EASDASLDRV LSLYPGSWSE GAPFRTGILN ALTPQFKRIA
AIFTDLLFQS PRRVMLNATK DVNRWTYLAT QLHNLVPFLG TFHGSDLLFQ YYVDLGPSSA
YRRYFISFAN HHDPNVGTNL KQWDMYTDSG KEMLQIHMIG NSMRTDDFRI EGISNFETDV
NLYG
SEQ ID NO: 5 is a lipase derived from Geotrichum candidum
QAPTAVLNGN EVISGVLEGK VDTFKGIPFA DPPVGDLREK HPQPFTGSYQ GLKANDESSA
CMQLDPGNAI SLLDKVVGLG KIIPDNLRGP LYDMAQGSVS MNEDCLYLNV FRPAGTKPDA
KLPVMVWIYG GAFVFGSSAS YPGNGYVKES VEMGQPVVFV SINYRTGPYG FLGGDAITAE
GNTNAGLHDQ RKGLEWVSDN IANFGGDPDK VMIFGESAGA MSVAHQLVAY GGDNTYNGKQ
LFHSAILQSG GPLPYFDSTS VGPESAYSRE AQYAGCDASA GDNETLACLR SKSSDVLHSA
QNSYDLKDLF GLLPQFLGFG PRPDGNIIPD AAYELYRSGR YAKVPYITGN QEDEGTILAP
VAINATTTPH VKKWLKYICS EASDASLDRV LSLYPGSWSE GAPFRTGILN ALTPQFKRIA
AIFTDLLFQS PRRVMLNATK DVNRWTYLAT QLHNLVPFLG TFHGSDLLFQ YYVDLGPSSA
YRRYFISFAN HHDPNVGTNL KQWDMYTDSG KEMLQIHMIG NSMRTDDERI EGISNFESDV
NLYG
SEQ ID NO: 6 is a lipase derived from Geotrichum candidum
QAPTAVLNGN EVISGVLEGK VDTFKGIPFA DPPVGDLREK HPQPFTGSYQ GLKANDESSA
CMQLDPGNAF SLLDKVVGLG KILPDNLRGP LYDMAQGSVS MNEDCLYLNV FRPAGTKPDA
KLPVMVWIYG GAFVEGSSAS YPGNGYVKES VEMGQPVVFV SINYRTGPYG FLGGDAITAE
GNTNAGLHDQ RKGLEWVSDN IANFGGDPDK VMIFGESAGA MSVAHQLVAY GGDNTYNGKQ
LFHSAILQSG GPLPYFDSTS VGPESAYSRE AQYAGCDTSA SDNDTLACLR SKSSDVLHSA
QNSYDLKDLF GLLPQFLGFG PRPDGNIIPD AAYELYRSGR YAKVPYITGN QEDEGTILAP
VAINATTTPH VKKWLKYICS QASDASLDRV LSLYPGSWSE GSPERTGILN ALTPQFKRIA
AIFTDLLFQS PRRVMLNATK DVNRWTYLAT QLHNLVPFLG TFHGSDLLFQ YYVDLGPSSA
YRRYFISFAN HHDPNVGTNL QQWDMYTDAG KEMLQIHMIG NSMRTDDERI EGISNFESDV
TLFG
SEQ ID NO: 7 is a serine protease (Protease BE)
AQSVPWGIRR VQAPTAHNRG LTGSGVKVAV LDTGISTHPD LNIRGGASFV PGEPSTQDEN
GHGTHAAGTI AALNNSIGVL GVAPSAELYA VKVLGASGSG SVSSIAQGLE WAGNNGMHVA
NLSLGSPSPS ATLEQAVNSA TSRGVLVVAA SGNSGAGSIS YPARYANAMA VGATDQNNNR
ASFSQYGPGL DIVAPGVNIQ STYPGSTYAS LNGTSMATPH VAGAAALVKQ KNPSWSNVRI
RNHLKNTATS LGSTDLYGSG LVNAEAATR
VNK
SEQ ID NO: 8 is an alpha-amylase (Alpha-Amylase SP)
HHNGTNGTLM QYFEWYLPND GNHWNRLRSD ASNLKDKGIS AVWIPPAWKG ASQNDVGYGA
YDLYDLGEFN QKGTIRTKYG TRNQLQAAVN ALKSNGIQVY GDVVMNHKGG ADATEMVKAV
EVNPNNRNQE VSGEYTIEAW TKEDEPGRAN THSNEKWRWY HEDGVDWDQS RKLNNRIYKE
RTKAWDWEVD TEFGNYDYLL YADIDMDHPE VVNELRNWGV WYTNTLGLDG FRIDAVKHIK
YSFTRDWINH VRSAIGKNMF AVAEFWKNDL GAIENYLNKT NWNHSVEDVP LHENLYYASK
SGGNYDMRQI FNGTVVQKHP THAVTFVDNH DSQPEESLES FVREWEKPLA YALTLTREQG
YPSVFYGDYY GIPTHGVPAM KSKIDPILEA RQKYAYGRQN DYLDHHNIIG WTREGNTAHP
NSGLATIMSD GAGGNKWMFV GRNKAGQVWT DITGNKAGTV TINADGWGNF SVNGGSVSIW
VNK

### DEFINITIONS

In accordance with this detailed description, the following definitions apply. Note that the singular forms “a,” “an,” and “the” include plural references unless the context clearly dictates otherwise. Unless defined otherwise or clearly indicated by context, all technical and scientific terms used herein have the same meaning as commonly understood by one of ordinary skill in the art to which this invention belongs.

### Lipase:

The terms “lipase” can be used, in context of the present invention, interchangably with the terms “lipase enzyme”, “lipolytic enzyme”, “lipid esterase”, “lipolytic polypeptide”, and “lipolytic protein” and refers to enzymes in class EC 3.1.1 as defined by IUBMB Enzyme Nomenclature. It may have lipase activity (triacylglycerol lipase, EC 3.1.1.3), cutinase activity (EC 3.1.1.74), sterol esterase activity (EC 3.1.1.13) and/or wax-ester hydrolase activity (EC3.1.1.50). In this context a “lipase substrate” is any substrate which can be hydrolyzed by a “lipase”. One example of a lipase substrate is fat (triglycerides). For purposes of the present invention lipase activity (i.e. the hydrolytic activity of the lipase) may be determined with a pNP assay using substrates with various chain length as described in Example 1.

### Parent Lipase:

The term “parent” or “parent lipase” means a lipase to which an alteration is made to produce the lipase variants. The parent lipase may be a naturally occurring (wild-type) polypeptide but may also be a variant and/or fragment thereof. In preferred embodiments, the parent lipase may be the ones shown in SEQ ID NOs: 1, 2, 3, 4, 5 and 6, respectively.
SEQ ID NO: 1 is the wild-type Thermomyces lanuginosus lipase (synonym Humicola lanuginosa DSM 4109 lipase) often referred to simply as “TLL”.
SEQ ID NO: 2 is a Geotrichum candidum lipase disclosed as SEQ ID NO: 1 in WO 2022/162043 (hereby incorporated by reference) and described by Bertolini et al (Eur. J. Biochem. 228, 863-869 (1995)) (hereby incorporated herein by reference) and referred to in brief as “GCL1”.
SEQ ID NO: 3 is a Geotrichum candidum lipase disclosed as SEQ ID NO: 2 in WO 2022/162043.
SEQ ID NO: 4 is a Geotrichum candidum lipase disclosed as SEQ ID NO: 4 in WO 2022/162043.
SEQ ID NO: 5 is a Geotrichum candidum lipase disclosed as SEQ ID NO: 5 in WO 2022/162043.
SEQ ID NO: 6 is a Geotrichum candidum lipase disclosed as SEQ ID NO: 6 in WO 2022/162043.

### Wild-Type Lipase:

The term “wild-type” lipase means a lipase expressed by a naturally occurring microorganism, such as a bacterium, yeast, or filamentous fungus found in nature. In an embodiment, the wild-type lipase is the one shown in SEQ ID NO: 1 herein, which is derived from Thermomyces lanuginosus DSM 4109 (synonym Humicola lanuginosa DSM 4109). In another preferred embodiment, the lipase is the one shown as SEQ ID NO: 2 herein, which is derived from a strain of Geotrichum candidum disclosed by Bertolini et al (Eur. J. Biochem. 228, 863-869 (1995)) and also disclosed as SEQ ID NO: 1 in WO 2022/162043.

### Mature Lipase:

The term “mature lipase” means a lipase in its mature form following N-terminal processing and/or C-terminal processing (e.g., removal of signal peptide) as well as glycosylation and phosphorylation.

### Variant:

The term “variant” means a polypeptide having enzymatic activity, in particular lipase activity, comprising a substitution, an insertion (including extension), and/or a deletion (e.g., truncation), at one or more positions. A substitution means replacement of the amino acid occupying a position with a different amino acid; a deletion means removal of the amino acid occupying a position; and an insertion means adding, e.g., 1-10 amino acids, such as 1-5 amino acids, in particular 1-3 amino acids, such as 1 amino acid) adjacent to and immediately following the amino acid occupying a position. In the context of the present invention the terms “variant” and “lipase variant” may be used interchangeably unless it is clear from the context that the variant refers to another enzyme class.

### Sequence Identity:

The relatedness between two amino acid sequences is described by the parameter “sequence identity”. For purposes of the present invention, the sequence identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), preferably version 5.0.0 or later. The parameters used are gap open penalty of 10, gap extension penalty of 0.5, and the EBLOSUM62 (EMBOSS version of BLOSUM62) substitution matrix. The output of Needle labeled “longest identity” (obtained using the -nobrief option) is used as the percent identity and is calculated as follows:

(Identical Residues×100)/(Length of Alignment−Total Number of Gaps in Alignment)

Automatic Dishwashing Detergent Composition (ADW composition):

The term “automatic dishwashing detergent composition” may be used interchangeably with the term “ADW composition”.

The term “automatic dishwashing detergent composition” refers to compositions that find use in cleaning of the surface of dishware/tableware, e.g., glass, ceramic, plastic and metal dishware/tableware, and the like, after automatic dishwashing in a dishwasher.

The composition may be in the form of a regular, compact, or concentrated liquid; a gel; a paste; a regular or a compacted powder; a granulated solid; a single unit dose (SUD), a homogenous or a multilayer tablet with two or more layers (same or different phases); a pouch having one or more compartments; a single or a multi-compartment unit dose form; or any combination thereof.

An ADW composition may contain one or more enzymes, such as especially proteases and amylases, but may also containing other enzyme activities such as cutinases, cellulases, pectin lyases, mannanases, DNase, or any mixture thereof, and/or ingredients such as surfactants, anti-foaming agents, builders, chelators or chelating agents, alkaline salts, bleach system or bleach components, polymers (as set forth herein), anti-corrosion agents, suds suppressors, dyes, perfume, gelling agents, bactericides, fungicides, soil suspending agents, enzyme inhibitors or stabilizers, enzyme activators, and solubilizers.

Automatic dishwashing detergent compositions of the invention are not suitable for use as laundry washing and vice versa. Automatic dishwashing detergent (ADW) compositions are distinct from laundry detergent compositions. The uses are different as laundry detergent compositions clean laundry and remove stains on laundry while automatic dishwashing detergent compositions of the invention clean dishware/tableware, and the like, which have hard surfaces. There are several differences in the compositions of laundry detergent compositions and automatic dishwashing detergent (ADW) compositions. Laundry detergent compositions are used in washing machines, e.g., top loaders or front loaders. Automatic dishwashing detergent compositions of the invention are used in automatic dishwashers. Automatic dishwashing detergent compositions of the invention may or may not include a surfactant. In a preferred embodiment, the automatic dishwashing detergent compositions of the invention only comprises nonionic surfactants, in particular alcohol ethoxylate (AE or AEO). Automatic dishwashing detergent compositions of the invention do not comprise anionic surfactants, in particular SLS, SLES and/or LAS. In a preferred embodiment, the automatic dishwashing detergent compositions of the invention comprise nonionic surfactants, in particular alcohol ethoxylate (AE or AEO), but not any anionic surfactants, in particular SLS, SLES and/or LAS. In contrast to automatic dishwashing compositions, laundry detergent compositions comprise anionic surfactants, in particular SLS, SLES and/or LAS. Anionic surfactants help remove soils and stains from clothing during the washing process. Anionic surfactants generate foam when coming into contact with water. Automatic dishwashing detergent compositions of the invention, on the other hand, are designed only to generate a minimum of foam during the dishwashing cycle, i.e., low foaming or non-foaming composition. Excessive foam generation can interfere with the dishwasher's cleaning capability and may even cause leaks or overflow. Therefore, automatic dishwashing detergent compositions of the invention contain non-foaming or low-foaming surfactants, such as nonionic surfactants, to ensure minimal foaming during the dishwashing cycle.

The automatic dishwashing detergent compositions of the invention do not contain anionic surfactants. In an embodiment, the automatic dishwashing detergent compositions of the invention do not contain sodium lauryl sulfate (SLS), sodium laureth sulfate (SLES) and/or linear alkylbenzene sulfonates (LAS). In an embodiment, the automatic dishwashing detergent compositions of the invention do not contain foaming surfactants. The automatic dishwashing detergent compositions of the invention are non-forming or low foaming compositions. The automatic dishwashing detergent composition of the invention only contains non-foaming or low foaming surfactants.

### Fatty Acids:

A fatty acid is a carboxylic acid with an aliphatic tail (chain), which is either saturated or unsaturated. Most naturally occurring fatty acids have a chain of an even number of carbon atoms, from 4 to 28. Fatty acids are usually derived from triglycerides or phospholipids. When they are not attached to other molecules, they are known as “free” fatty acids. Examples of fatty acids include, but are not limited to, butanoic acid (butyric acid), pentanoic acid (valeric acid), hexanoic acid (caproic acid), heptanoic acid (enanthic acid), octanoic acid (caprylic acid), nonanoic acid (pelargonic acid), decanoic acid (capric acid), dodecanoic acid (lauric acid), tetradecanoic acid (myristic acid), hexadecanoic acid (palmitic acid), octadecanoic acid (stearic acid), eicosanoic acid (arachidic acid) oleic acid, palmitoleic acid linoleic acid, linolenic acid, arachidonic acid, eicosapentaenoic acid, and docosahexaenoic acid. It is to be understood that in the context of this invention, a fatty acid and an acyl group of a lipid are equivalents. When the fatty acid is an acyl group of a lipid, the lipid can be a monoglyceride, diglyceride, triglyceride, phospholipid, sphingolipid, galactolipid, sterolester or wax ester. The acyl group may be saturated, or unsaturated, and optionally functional groups (substituents) may be attached. Examples of acyl groups include, but are not limited to, the acyl forms of butanoic acid (butyric acid), pentanoic acid (valeric acid), hexanoic acid (caproic acid), heptanoic acid (enanthic acid), octanoic acid (caprylic acid), nonanoic acid (pelargonic acid), decanoic acid (capric acid), dodecanoic acid (lauric acid), tetradecanoic acid (myristic acid), hexadecanoic acid (palmitic acid), octadecanoic acid (stearic acid), eicosanoic acid (arachidic acid), linoleic acid, linolenic acid, arachidonic acid, eicosapentaenoic acid, oleic acid, palmitoleic acid, and docosahexaenoic acid. Some fatty acids such as, e.g., butyric acid, have an undesired smell/odor.

### Improved Property:

The term “improved property” means a characteristic associated with an automatic dishwashing detergent composition which is improved compared to a reference composition. Such improved properties include, but are not limited to, increased fat removal, reduced odor generation and/or reduced fatty acid salt residues on the surface of dishware/tableware and the like after cleaning in a dishwasher.

### Testing Fat Removal:

For the purpose of the present invention, fat removal can be determined as described in the Examples by comparing the wt. % fat removal with and without the lipase in question or against the wt. % fat removal of a reference lipase.

### Testing for Fatty Acid Salt Residues Removal:

For the purpose of the present invention, a lipase's ability to reduce slimy fatty acid salt residues can be determined as described in the Examples by comparing the remaining slimy fatty acid salt residues on the surface of dishware/tableware, and the like, after cleaning in a dishwasher against the same cleaning process with another reference lipase.

### Odor:

The term “odor” means an undesired smell. Unless otherwise specified the term odor may be used interchangeably with the term “malodor” or “undesired smell”.

### Testing for Reduced Odor Generation:

For the purpose of the present invention, reduced odor generation may, as described in the Examples, be determined
1) on an odor intensity scale by a trained odor panel,
2) by analytical methods, including the butanoic acid (butyric acid) release method described in WO 2017/001673 (see page 91, line 27+) where odor caused by lipase is measured by Solid Phase Micro Extraction Gas Chromatography (SPME-GC).

### Wash Cycle:

The term “wash cycle” is defined herein as a cleaning operation carried out in an automatic dishwasher. In general terms, a wash cycle in a standard commercial dishwasher comprises the following steps:
Adds water
Heats the water to the appropriate temperature
Automatically opens the detergent composition dispenser at the right time
Shoots the water through spray arms to get the dishware/tableware clean
Drains the dirty water
Sprays more water on the dishware/tableware to rinse them
Drains itself again
Optionally, heats the air to dry the dishware/tableware, or the like.

### Wash Liquor:

In context of the present invention, the water, comprising an ADW composition in dilute form, is termed “wash liquor” or “wash water”.

### Weight Percentage:

Weight percentage is abbreviated w/w % or wt. %. The abbreviations are used interchangeably.

### Conventions for Designation of Variants

For purposes of the present invention, the lipases disclosed in SEQ ID NOs: 1, 2, 3, 4, 5, and 6, respectively, are used to determine the corresponding amino acid positions in lipase variants thereof.

The amino acid sequence of a lipase variant in question is aligned with the parent lipase disclosed in SEQ ID NOs: 1, 2, 3, 4, 5, and 6, respectively, and based on the alignments, the amino acid position number corresponding to any amino acid residue in the lipase variant in question is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), preferably version 5.0.0 or later. The parameters used are gap open penalty of 10, gap extension penalty of 0.5, and the EBLOSUM62 (EMBOSS version of BLOSUM62) substitution matrix.

In describing the variants of the present invention, the nomenclature described below is adapted for ease of reference. The accepted IUPAC single letter or three letter amino acid abbreviation is employed.

### Substitutions

For an amino acid substitution, the following nomenclature is used: Original amino acid, position, substituted amino acid. Accordingly, the substitution of threonine at position 226 with alanine is designated as “Thr226Ala” or “T226A”. Multiple mutations are separated by addition marks (“+”) or comma (“,”), e.g., “Gly205Arg+Ser411 Phe” or “G205R+“S411F”, Gly205Arg,Ser411 Phe” or “G205R,S411F” representing substitutions at positions 205 and 411 of glycine (G) with arginine (R) and serine (S) with phenylalanine (F), respectively.

### Deletions

For an amino acid deletion, the following nomenclature is used: Original amino acid, position, *. Accordingly, the deletion of glycine at position 195 is designated as “Gly195*” or “G195*”. Multiple deletions are separated by addition marks (“+”) or commas (“,”), e.g., “Gly195*+Ser411*” or “G195*+S411*”.

### Insertions

For an amino acid insertion, the following nomenclature is used: Original amino acid, position, original amino acid, inserted amino acid. Accordingly, the insertion of lysine after glycine at position 195 is designated “Gly195GlyLys” or “G195GK”. An insertion of multiple amino acids is designated [Original amino acid, position, original amino acid, inserted amino acid #1, inserted amino acid #2; etc.]. For example, the insertion of lysine and alanine after glycine at position 195 is indicated as “Gly195GlyLysAla” or “G195GKA”.

In such cases the inserted amino acid residue(s) are numbered by the addition of lower case letters to the position number of the amino acid residue preceding the inserted amino acid residue(s). In the above example, the sequence would thus be:

| Parent: | Variant: |
|---|---|
| 195 | 195 195a 195b |
| G | G - K - A |

### Multiple Alterations

Variants comprising multiple alterations are separated by addition marks (“+”) or by commas (“,”), e.g., “Arg170Tyr+Gly195Glu”, “R170Y+G195E”, “Arg170Tyr,Gly195Glu” or “R170Y,G195E” representing a substitution of arginine and glycine at positions 170 and 195 with tyrosine and glutamic acid, respectively.

### Different Alterations

Where different alterations can be introduced at a position, the different alterations are separated by a comma or slash (“/”), e.g., “Arg170Tyr,Glu” or “Arg170Tyr/Glu” represents a substitution of arginine at position 170 with tyrosine or glutamic acid. Thus, “Tyr167Gly,Ala+Arg170Gly,Ala” or “Tyr167Gly/Ala+Arg170Gly/Ala” designates the following variants: “Tyr167Gly+Arg170Gly”, “Tyr167Gly+Arg170Ala”, “Tyr167Ala+Arg170Gly”, and “Tyr167Ala+Arg170Ala”.

### Unspecified Amino Acid

Unless otherwise limited further, the amino acid X (or Xaa) is used herein to represent any of the 20 natural amino acids. An “X” preceding a position means that any original amino acid at that position may be substituted. For example, X93Q means that any amino acid residue at position 93 other than Q is substituted with Q. This allows for designation of substitution to a particular amino acid in different parent mannanases, where the original amino acid may vary among different parent polypeptides.

### DETAILED DESCRIPTION OF THE INVENTION

### Automatic Dishwashing Detergent Compositions of the Invention

The present invention relates to automatic dishwashing detergent compositions (ADW compositions) capable of reducing the amount of fat present on the surface of dishware/tableware, e.g., glass, ceramic, plastic, and metal dishware/tableware, and the like, after cleaning in a dishwasher.

In the first aspect, the invention relates to an automatic dishwashing detergent composition comprising a lipase.

### Lipases

The lipase used in the automatic dishwashing detergent composition of the invention may be any lipase or lipase variant. Suitable lipases include those of bacterial or fungal origin. Chemically modified or protein engineered mutant enzymes are included. Examples include lipase from Thermomyces, e.g. from T. lanuginosus (previously named Humicola lanuginosa) as described in EP258068 and EP305216, lipase from strains of Pseudomonas (some of these now renamed to Burkholderia), e.g. P. alcaligenes or P. pseudoalcaligenes (EP218272), P. cepacia (EP331376), P. sp. strain SD705 (WO95/06720 & WO96/27002), P. wisconsinensis (WO96/12012), GDSL-type Streptomyces lipases (WO10/065455), lipase from Thermobifida fusca (WO11/084412), Geobacillus stearothermophilus lipase (WO11/084417), lipase from Bacillus subtilis (WO11/084599), and lipase from Streptomyces griseus (WO11/150157) and S. pristinaespiralis (WO12/137147) and the lipase from Geotrichum candidum (GCL1) disclosed in WO 2022/162043 (hereby incorporated by reference).

Examples of lipase variants such as those described in EP407225, WO92/05249, WO94/01541, WO94/25578, WO95/14783, WO95/30744, WO95/35381, WO95/22615, WO96/00292, WO97/04079, WO97/07202, WO00/34450, WO00/60063, WO01/92502, WO07/87508 and WO09/109500, WO 2014/184164, WO 2016/050661, WO 2018/001959, WO 2019/063499 (all incorporated by reference).

Suitable commercial lipase products include include Lipolase 100T/L, Lipex 100T/L, Lipex 105T, Lipex Evity 100L, Lipex Evity 105T, Lipex Evity 200L), Lipolex™, Lipoclean™ (all Novozymes A/S), Preferenz® L 100 (Danisco US Int), Lumafast (originally from Genencor), Preferenz L100 (Danisco US Inc.), and Lipomax (originally from Gist-Brocades).

The variants may further comprise an extension (or peptide addition) of one or more amino acids at the N-terminal and/or C-terminal ends (see WO 1997/004079 or WO 2000/060063).

Alternatively, the variants may further comprise a truncation of one or more amino acids at the N-terminal and/or C-terminal ends.

Thermomyces lanuginosus Lipase (TLL)—SEQ ID NO: 1

In an embodiment, the lipase used according to the invention, i.e., comprised in an automatic dishwashing detergent composition of the invention, is the lipase shown in SEQ ID NO: 1, or a variant thereof.

In an embodiment, the lipase is the parent lipase shown in SEQ ID NO: 1 or a lipase having at least 60%, at least 65%, at least 70%, at least 75%, at least 80%, at least 85%, at least 90%, at least 95% identity, at least 96%, at least 97%, at least 98%, or at least 99%, or 100% sequence identity to SEQ ID NO: 1.

In a preferred embodiment, the lipase is a lipase variant having lipase activity and comprises one or more of the following substitutions corresponding to E1C, T231R, N233R, and N233C of SEQ ID NO: 1.

In an embodiment, the lipase is a lipase variant comprising substitutions corresponding to T231R+N233R, and optionally at least one or more (e.g., several) of D96E, D111A, D254S, G163K, P256T, G91T and G38A of SEQ ID NO: 1.

In specific embodiments, the lipase is a lipase variant comprising substitutions corresponding to the substitutions selected from the following set of substitutions in SEQ ID NO: 1:

R231R + N233R;
D96E + T231R + N233R;
N33Q + D96E + T231R + N233R;
N33Q + D111A + T231R + N233R;
N33Q + T231R + N233R + P256T;
N33Q + G38A + G91T + G163K + T231R + N233R + D254S;
N33Q + G38A + G91T + D96E + D111A + G163K + T231R + N233R + D254S + P256T;
D27R + N33Q + G38A + D96E + D111A + G163K + T231R + N233R + D254S + P256T;
D27R + N33Q + G38A + G91T + D96E + D111A + G163K + T231R + N233R + P256T;
D27R + N33Q + G38A + G91T + D96E + D111A + G163K + T231R + N233R + D254S;
D27R + G38A + G91T + D96E + D111A + G163K + T231R + N233R + D254S + P256T;
D96E + T231R + N233R + D254S;
T231R + N233R + D254S + P256T;
G163K + T231R + N233R + D254S;
D27R + N33Q + G38A + G91T + D96E + G163K + T231R + N233R + D254S + P256T;
D27R + G91T + D96E + D111A + G163K + T231R + N233R + D254S + P256T;
D96E + G163K + T231R + N233R + D254S;
D27R + G163K + T231R + N233R + D254S;
D27R + G38A + G91T + D96E + D111A + G163K + T231R + N233R + D254S;
D27R + G38A + G91T + D96E + G163K + T231R + N233R + D254S + P256T;
D27R + G38A + D96E + D111A + G163K + T231R + N233R + D254S + P256T;
D27R + D96E + G163K + T231R + N233R + D254S;
D27R + D96E + D111A + G163K + T231R + N233R + D254S + P256T;
D27R + G38A + D96E + G163K + T231R + N233R + D254S + P256T
D111A + G163K + T231R + N233R + D254S + P256T;
D111A + T231R + N233R;
D111A + T231R + N233R + D254S + P256T;
D27R + D96E + D111A + G163K + T231R + N233R;
D27R + D96E + D111A + T231R + N233R;
D27R + N33Q + G38A + D96E + D111A + T231R + N233R + D254S + P256T;
D27R + G38A + D96E + D111A + G163K + E210Q + T231R + N233R + D254S + P256T;
D27R + T231R + N233R + D254S + P256T;
D96E + D111A + G163K + T231R + N233R;
D96E + D111A + G163K + T231R + N233R + D254S + P256T;
D96E + D111A + G163K + T231R + N233R + P256T;
D96E + D111A + T231R + N233R;
D96E + D111A + T231R + N233R + D254S;
D96E + D111A + T231R + N233R + D254S + P256T
D96E + D111A + T231R + N233R + P256T;
D96E + G163K + T231R + N233R + D254S + P256T;
D96E + T231R + N233R + D254S + P256T;
D96E + T231R + N233R + P256T;
G38A + D96E + D111A + T231R + N233R;
G91T + D96E + D111A + G163K + T231R + N233R + D254S + P256T;
G91T + D96E + D111A + T231R + N233R;
G91T + D96E + T231R + N233R;
G91T + T231R + N233R + D254S + P256T;
N33Q + D96E + D111A + G163K + T231R + N233R + D254S + P256T;
T231R + N233R + D254S + P256T;
T231R + N233R + P256T.

In another embodiment, the lipase is a lipase variant, wherein said variant
(a) comprises a modification in at least one position corresponding to positions E1, V2, N33, F51, E56, L69, K98, V176, H198, E210, Y220, L227, and K237 of SEQ ID NO: 1; and optionally further comprises a modification in at least one position corresponding to positions D27, G38, D96, D111, G163, T231, N233, D254, and P256 of SEQ ID NO: 1;
(b) has a sequence identity of at least 60% but less than 100% to SEQ ID NO: 1;
(c) has lipase activity.

In an embodiment, the lipase is a variant comprising a modification corresponding to at least one of the following positions of SEQ ID NO: 1: E1, V2, D27, N33, G38, F51, E56, L69, D96, K98, D111, G163, V176, H198, E210, Y220, L227, T231, N233, K237, D254, and P256.

In an embodiment, the lipase is a lipase variant comprising at least one modification corresponding to the following modifications of SEQ ID NO: 1: E1C, V2Y, D27R, N33K, N33Q, G38A, F51V, E56K, L69R, D96E, D96L, K981, K98Q, D111A, G163K, V176L, H198S, E210K, Y220F, L227G, T231R, N233R, N233C, K237C, D254S, and P256T.

In an embodiment, the lipase is a lipase variant further comprises one of the substitutions corresponding to the substitutions in SEQ ID NO: 1 selected from the group of: S54T, S83T, G91A, A150G, 1255A, and E239C.

In a preferred embodiment lipase is a variant comprising substitutions E1C+N233C, and optionally one or more additional substitutions, wherein numbering is according to SEQ ID NO: 1.

In specific embodiments, the lipase is a variant comprising substitutions corresponding to the substitutions selected from the following set of substitutions of SEQ ID NO: 1:

E1C + N233C;
E1C + H198L + N233C;
E1C + H198G + N233C;
E1C + L69V + N233C;
E1C + L69T + N233C;
E1C + L69S + N233C;
E1C + L69H + N233C;
E1C + L69F + N233C;
E1C + L69C + N233C;
E1C + H198Y + N233C;
E1C + H198T + N233C;
E1C + H198G + N233C;
E1C + L227F + N233C;
E1C + L227R + N233C;
E1C + E210T + N233C;
E1C + E210N + N233C;
E1C + V176M + N233C;
E1C + K98T + N233C;
E1C + K98E + N233C;
E1C + E56S + N233C;
E1C + E56Q + N233C;
E1C + E56R + N233C;
E1C + F51M + N233C;
E1C + D27R + F51Y + N233C;
E1C + V21 + N233C;
E1C + V2N + N233C;
E1C + V2K + N233C;
E1C + V2A + N233C;
E1C + D96L + N233C;
E1C + L69R + N233C;
E1C + V2Y + N233C;
E1C + N233C + P256T;
E1C + N233C + D254S;
E1C + T231R + N233C;
E1C + H198S + N233C;
E1C + D111A + N233C;
E1C + D96E + N233C;
E1C + G38A + N233C;
E1C + N33Q + N233C;
E1C + N33K + N233C;
E1C + E210A + N233C;
E1C + E210Q + N233C;
E1C + E210R + N233C;
E1C + H198D + N233C;
E1C + K98R + N233C;
E1C + K98V + N233C;
E1C + F51L + N233C;
E1C + F511 + N233C;
E1C + K237C;
E1C + L227G + N233C;
E1C + E210K + N233C;
E1C + V176L + N233C;
E1C + K98Q + N233C;
E1C + E56K + N233C;
E1C + L147S + N233C + D254S;
E1C + Y220F + N233C;
E1C + K981 + N233C;
E1C + D27R + F511 + E56R + K98E + T231R + N233C;
E1C + D27R + F511 + E56R + K98E + T231R + N233C + D254S;
E1C + D27R + G38A + F51L + K98I + D111A + G163S +
H198S + Y220F + T231R + N233C + P256T;
E1C + D27R + G38A + F51L + D96E + K98I + D111A +
G163K + H198S + Y220F + T231R + N233C + D254S P256T;
E1C + D27R + G38R + F51L + D96E + K98I + D111A +
G163K + H198S + Y220F + T231R + N233C + D254S + P256T;
E1C + D27R + F51L + D96| + K98I + D111A + G163K +
H198S + Y220F + T231R + N233C + P256T;
E1C + D27R + F51L + D96E + K98I + D111A + G163S +
H198S + Y220F + T231R + N233C + P256T;
E1C + D27R + F51L + D96E + K98I + D111A + G163K +
H198S + Y220F + T231R + N233C + P256T;
E1C + D27R + G38A + F51I + D96E + K98I + D111A +
G163K + H198S + Y220F + T231R + N233C + D254S + P256T;
E1C + D27R + G38A + F51V + D96E + K98I + D111A +
G163K + H198S + Y220F + T231R + N233C + P256T;
E1C + D27R + F51V + D96E + K98I + D111A + G163K +
H198S + Y220F + T231R + N233C + P256T;
E1C + D27R + F51V + D96E + K98I + D111A + G163S +
H198S + Y220F + T231R + N233C + D254S + P256T;
E1C + D27R + F51V + D96| + K98I + D111A + G163K +
H198S + Y220F + T231R + N233C + D254S + P256T;
E1C + D27R + F51V + K98I + D111A + G163K + H198S +
Y220F + T231R + N233C + D254S + P256T;
E1C + D27R + F51V + D96E + K98I + D111A + G163K +
H198S + Y220F + T231R + N233C + D254S + P256T;
E1C + D27R + G38A + F51V + D96E + K98I + D111A +
G163K + H198S + Y220F + T231R + N233C + D254S + P256T;
E1C + F51V + D96E + K98I + D111A + G163S + H198S +
Y220F + T231R + N233C + P256T;
E1C + F51L + D96E + K98I + D111A + G163K + H198S +
Y220F + T231R + N233C + D254S + P256T;
E1C + G38A + F51V + D96E + K98I + D111A + G163K +
H198S + Y220F + T231R + N233C + P256T;
E1C + F51V + D96E + K98I + D111A + G163K + H198S +
Y220F + T231R + N233C + P256T;
E1C + F51V + D96| + K98I + D111A + G163K + H198S +
Y220F + T231R + N233C + D254S + P256T;
E1C + F51V + K98I + D111A + G163K + H19S + Y220F +
T231R + N233C + D254S + P256T;
E1C + F51I + D96E + K98I + D111A + G163K + H198S +
Y220F + T231R + N233C + D254S + P256T;
E1C + D27R + F51L + D96E + K98I + D111A + G163K +
H198S + Y220F + T231R + N233C + D254S + P256T;
E1C + D27R + N33K + G38A + F51V + D96E + K98I + D111A +
G163K + H198S + Y220F + T231R + N233C;
E1C + G38R + F51V + D96E + K98I + D111A + G163K + H198S +
Y220F + T231R + N233C + D254S + P256T;
E1C + F51V + D96E + K98I + D111A + G163K + H198S + Y220F +
T231R + N233C + D254S + P256T;
E1C + G38A + F51V + D96E + K98I + D111A + G163K + H198S +
Y220F + T231R + N233C + D254S + P256T;
E1C + D27R + G38R + F51V + D96E + K98I + D111A + G163K +
H198S + Y220F + T231R + N233C + D254S + P256T.

According to the invention, the lipase, or lipase variant, may be derived from a strain of Thermomyces, in particular Thermomyces lanuginosus (TLL), especially the parent lipase of SEQ ID NO: 1.

According to invention, the ADW composition of the invention provides increased fat removal on washed dishware/tableware, and the like's surfaces compared to when no lipase in particular any one of SEQ ID NOs: 1,2,3,4,5 or 6, is comprised in the composition.

In an embodiment, the lipase variant has at least 60%, at least 65%, at least 70%, at least 75%, at least 80%, at least 85%, at least 90%, at least 95% identity, at least 96%, at least 97%, at least 98%, or at least 99%, but less than 100% sequence identity to SEQ ID NO: 1.

Geotrichum candidum Lipases (GCL)—SEQ ID NOs: 2-6

The invention also relates to ADW compositions comprising a GCL (i.e., lipases in SEQ ID NO: 2-6) and/or variants thereof. Such lipases are surprisingly good at reducing slimy fatty acid salt residues on the surface of dishware/tableware, and the like, compared to Thermomyces lanuginosus (TLL) lipases after dishwashing. Such lipases also generate less malodor than the Thermomyces lanuginosus lipase after dishwashing.

Therefore, in a preferred embodiment, the lipase used according to the invention, is derived from Geotrichum candidum.

In a preferred embodiment, the lipase used according to the invention is the lipase in SEQ ID NO: 2. In an embodiment, the parent lipase is the one shown in SEQ ID NO: 2, or a lipase having at least 60%, at least 65%, at least 70%, at least 75%, at least 80%, at least 85%, at least 90%, at least 95% identity, at least 96%, at least 97%, at least 98%, or at least 99%, or 100% sequence identity to SEQ ID NO: 2.

In another preferred embodiment the lipase used according to the invention is the lipase in SEQ ID NO: 3. In an embodiment, the parent lipase is the one shown in SEQ ID NO: 3, or a lipase having at least 60%, at least 65%, at least 70%, at least 75%, at least 80%, at least 85%, at least 90%, at least 95% identity, at least 96%, at least 97%, at least 98%, or at least 99%, or 100% sequence identity to SEQ ID NO: 3.

In another preferred embodiment, the lipase used according to the invention is the lipase in SEQ ID NO: 4. In an embodiment the parent lipase is the one shown in SEQ ID NO: 4, or a lipase having at least 60%, at least 65%, at least 70%, at least 75%, at least 80%, at least 85%, at least 90%, at least 95% identity, at least 96%, at least 97%, at least 98%, or at least 99%, or 100% sequence identity to SEQ ID NO: 4.

In another preferred embodiment, the lipase used according to the invention is the lipase in SEQ ID NO: 5. In an embodiment, the parent lipase is the one shown in SEQ ID NO: 5, or a lipase having at least 60%, at least 65%, at least 70%, at least 75%, at least 80%, at least 85%, at least 90%, at least 95% identity, at least 96%, at least 97%, at least 98%, or at least 99%, or 100% sequence identity to SEQ ID NO: 5.

In a preferred embodiment, the lipase used according to the invention is the lipase in SEQ ID NO: 6. In an embodiment, the parent lipase is the one shown in SEQ ID NO: 6, or a lipase having at least 60%, at least 65%, at least 70%, at least 75%, at least 80%, at least 85%, at least 90%, at least 95% identity, at least 96%, at least 97%, at least 98%, or at least 99%, or 100% sequence identity to SEQ ID NO: 6.

In an embodiment, the lipase is a lipase variant comprising one or more substitutions at one or more positions corresponding to positions 396, 397, 398, 408, 409, 166 and 325 of SEQ ID NOs: 2, 3, 4, 5 or 6, respectively.

In an embodiment, the lipase is a lipase variant comprising a substitution corresponding to position 396 and one or more further substitutions corresponding to positions of SEQ ID NOs: 2, 3, 4, 5 and 6, respectively, selected from the group consisting of 397, 398, 408, 409, 166 and 325.

The corresponding positions can be in any one of the lipases in SEQ ID NOs: 2, 3, 4, 5, and 6, respectively.

In an embodiment, the lipase is a lipase variant, wherein the substitution at position 396 corresponds to a substitution in SEQ ID NOs: 2, 3, 4, 5 and 6, respectively, selected from the group consisting of G396E, G396Q, G396R, G396K, G396W, G396S, G396A, G396V, G396M, G396P, G396N, G3961, G396D and G396H.

In an embodiment, the lipase is a variant, wherein the substitution at position 408 corresponds to a substitution in SEQ ID NOs: 2, 3, 4, 5 and 6, respectively, selected from the group consisting of I408R, I408D, I408E, I408Q, I408M, I408S, I408G, I408A, I408K, I408P, I408L, I408W, I408V, W398D, I408H, I408Y and I408F.

In an embodiment, the lipase is a lipase variant further comprising one or more substitutions corresponding to S397D, S397N, S397T, S397E, W398P, W398L, W398Y, W398V, W398A, W3981, W398R, W398T, W398K, W398S, W398M, L409R, L409K, L409H, L409N, L409E, L409Q, L409D, L409Y, L409S, G325D, G325K, T166L, T166W and T166G using SEQ ID NOs: 2, 3, 4, 5 and 6, respectively, for numbering.

In specific embodiments, the lipase is a variant, wherein the variant is selected from the group of variants:
a. Variant of the polypeptide of SEQ ID NOs: 2, 3, 4, 5 and 6, respectively, comprising the substitutions G396E, S397D, W398P, 1408R and L409R;
b. Variant of the polypeptide of SEQ ID NOs: 2, 3, 4, 5 and 6, respectively, comprising the substitutions T166L, G325D, G396E, W398Y and L409R;
c. Variant of the polypeptide of SEQ ID NOs: 2, 3, 4, 5 and 6, respectively, comprising the substitutions W398P and 1408E;
d. Variant of the polypeptide of SEQ ID NOs: 2, 3, 4, 5 and 6, respectively, comprising the substitutions T166L, G325D, G396E and W398Y.

According to invention, the lipase variant has at least 60%, at least 65%, at least 70%, at least 75%, at least 80%, at least 85%, at least 90%, at least 95% identity, at least 96%, at least 97%, at least 98%, or at least 99%, but less than 100% sequence identity to SEQ ID NOs: 2, 3, 4, 5, and 6, respectively.

In an embodiment, the composition provides increased fat (i.e., triglyceride) removal on dishware/tableware, and the like, cleaned surfaces compared to when no lipase in particular any one of SEQ ID NOs: 1, 2, 3, 4, 5 or 6, is comprised in the ADW composition and/or reduced amount of fatty acid salt residues compared to when the lipase in SEQ ID NO: 1, or a variant thereof defined above, is used.

In an embodiment, the composition of the invention provides reduced odor generation after dishwashing compared to when the Thermomyces lanuginosus lipase in SEQ ID NO: 1, or a variant thereof defined above, is used.

In an embodiment, the lipase is a lipase variant having from 1-40, 1-30, 1-20, such as 1-12, such as 1-11, such as 1-10, such as 1-9, such as 1-8, such as 1-7, such as 1-6, such as 1-5, such as 1-4, such as 1-3, or such as 1, 2, 3, 4, 5, 6, 7, 8, 9, 10, 11, 12, 13, 14, 15, 16, 17, 18, 19, or20 mutations, especially substitutions.

### Automatic Dishwashing Detergent Composition Ingredients:

An automatic dishwashing composition of the invention may include additional ingredients, i.e., other than a lipase, in particular the lipases and lipase variants defined above. The precise nature of additional ingredients, and levels of incorporation thereof, will depend on, e.g., the physical form of the ADW composition. Suitable ingredients (adjunct materials) include but are not limited to the components described below such as components selected from the group of builders, chelators or chelating agents, bleaching systems, bleach activators, bleach catalysts, polymers, surfactants, other enzymes, buffers. Such ingredients, and the dosing therefore, are well known to the skilled person in the art.

Examples of suitable builders include zeolites, phosphates, such as diphosphates (pyrophosphates), sodium tripolyphosphate (STPP), alkali metal citrates, carbonates and bicarbonates; and the salts of nitrilotriacetic acid (NTA); methylglycine diacetic acid (MGDA); glutaric diacetic acid (GLDA), polycarboxylates such as polymaleates, polyacetates, polyhydroxyacrylates, polyacrylate/polymaleate and polyacrylate/polymethacrylate copolymers, as well as zeolites; layered silicas and mixtures thereof.

In an embodiment of the invention, the composition is phosphate-free.

Examples of suitable bleach systems, include in particular one which comprises hydrogen peroxide (H₂O₂) or a source of hydrogen peroxide such as perborate or percarbonate which may be combined with a peracid-forming bleach activator such as tetraacetylethylenediamine (TAED) or nonanoyloxybenzenesulfonate (NOBS), a bleaching system, e.g., comprising peroxyacids of amide, imide, or sulfone type, or a bleach catalyst, such as 1,4,7-trimethyl-1,4,7-triazacyclononane manganese (MnTACN).

Examples of suitable surfactants, include in particular a non-ionic surfactant, including fatty alcohol polyglycolether, alcohol ethoxylates (AE or AEO) e.g. the AEO-series such as AEO-7, alcohol propoxylates, in particular propoxylated fatty alcohols (PFA), ethoxylated and propoxylated alcohols, alkoxylated fatty acid alkyl esters, such as ethoxylated and/or propoxylated fatty acid alkyl esters (in particular methyl ester ethoxylates, MEE), alkylpolyglycosides (APG), alkoxylated amines, fatty acid monoethanolamides (FAM), fatty acid diethanolamides (FADA), ethoxylated fatty acid monoethanolamides (EFAM), propoxylated fatty acid monoethanolamides (PFAM), polyhydroxyalkyl fatty acid amides, or N-acyl N-alkyl derivatives of glucosamine (glucamides, GA, or fatty acid glucamides, FAGA), as well as products available under the trade names SPAN and TWEEN, and combinations thereof.

Examples of antiredeposition agents, include sodium carboxymethylcellulose (CMC), methylcellulose, polyvinylpyrrolidone (PVP), polyvinyl alcohol, and polyethylene glycol (PEG).

Examples of suitable buffers, include carbonate and MOPS (3-(N-morpholino)propanesulfonic acid).

According to the invention, the automatic dishwashing detergent composition may be in the form of a composition selected from the group consisting of, e.g., a regular, compact or concentrated liquid; a gel; a paste; a regular or a compacted powder; a granulated solid; a single unit dose (SUD), a homogenous or a multilayer tablet with two or more layers (same or different phases); a pouch having one or more compartments; a single or a multi-compartment unit dose form; or any combination thereof. a solid/powder/granulate composition, liquid, gel or paste composition. Non-limited examples of other enzymes include proteases, amylases, cellulases, pectate lyases, mannanases, DNases. Preferred other enzymes are proteases and/or amylases.

### Proteases:

In one aspect, a preferred other enzyme in an automatic dishwashing detergent composition of the invention is a protease. Suitable proteases include those of bacterial, fungal, plant, viral or animal origin e.g. vegetable or microbial origin. Proteases of microbial origin are preferred. Chemically modified or protein engineered mutants are included. It may be an alkaline protease, such as a serine protease or a metalloprotease. A serine protease may for example be of the S1 family, such as trypsin, or the S8 family such as subtilisin. A metalloproteases protease may for example be a thermolysin from e.g. family M4 or other metalloprotease such as those from M5, M7 or M8 families.

The term “subtilases” refers to a sub-group of serine protease according to Siezen et al., Protein Engng. 4 (1991) 719-737 and Siezen et al. Protein Science 6 (1997) 501-523. Serine proteases are a subgroup of proteases characterized by having a serine in the active site, which forms a covalent adduct with the substrate. The subtilases may be divided into 6 sub-divisions, i.e. the Subtilisin family, the Thermitase family, the Proteinase K family, the Lantibiotic peptidase family, the Kexin family and the Pyrolysin family.

Examples of subtilases are those derived from Bacillus such as Bacillus lentus, B. alkalophilus, B. subtilis, B. amyloliquefaciens, Bacillus pumilus and Bacillus gibsonii described in; U.S. Pat. No. 7,262,042 and WO09/021867, and subtilisin lentus, subtilisin Novo, subtilisin Carlsberg, Bacillus licheniformis, subtilisin BPN′, subtilisin 309, subtilisin 147 and subtilisin 168 described in WO89/06279 and protease PD138 described in (WO93/18140). Other useful proteases may be those described in WO92/175177, WO01/016285, WO02/026024 and WO02/016547. Examples of trypsin-like proteases are trypsin (e.g. of porcine or bovine origin) and the Fusarium protease described in WO89/06270, WO94/25583 and WO05/040372, and the chymotrypsin proteases derived from Cellumonas described in WO05/052161 and WO05/052146.

A further preferred protease is the alkaline protease from Bacillus lentus DSM 5483, as described for example in WO95/23221, and variants thereof which are described in WO92/21760, WO95/23221, EP1921147 and EP1921148.

Examples of metalloproteases are the neutral metalloprotease as described in WO07/044993 (Genencor Int.) such as those derived from Bacillus amyloliquefaciens.

Examples of useful proteases are the variants described in: WO92/19729, WO96/034946, WO98/20115, WO98/20116, WO99/011768, WO01/44452, WO03/006602, WO04/03186, WO04/041979, WO07/006305, WO11/036263, WO11/036264, especially the variants with substitutions in one or more of the following positions: 3, 4, 9, 15, 27, 36, 57, 68, 76, 87, 95, 96, 97, 98, 99, 100, 101, 102, 103, 104, 106, 118, 120, 123, 128, 129, 130, 160, 167, 170, 194, 195, 199, 205, 206, 217, 218, 222, 224, 232, 235, 236, 245, 248, 252 and 274 using the BPN′ numbering. More preferred the subtilase variants may comprise the mutations: S3T, V41, S9R, A15T, K27R, *36D, V68A, N76D, N87S,R, *97E, A98S, S99G,D,A, S99AD, S101G,M,R S103A, V1041,Y,N, S106A, G118V,R, H120D,N, N123S, S128L, P129Q, S130A, G160D, Y167A, R170S, A194P, G195E, V199M, V2051, L217D, N218D, M222S, A232V, K235L, Q236H, Q245R, N252K, T274A (using BPN′ numbering).

Suitable commercially available protease enzymes include those sold under the trade names Alcalase®, Blaze®; Duralase™, Durazym™, Relase®, Relase® Ultra, Savinase®, Savinase® Ultra, Primase®, Polarzyme®, Kannase®, Liquanase®, Liquanase® Ultra, Ovozyme®, Coronase®, Coronase® Ultra, Neutrase®, Everlase® and Esperase® all could be sold as Ultra® or Evity® (Novozymes A/S), those sold under the tradename Maxatase®, Maxacal®, Maxapem®, Purafect®, Purafect Prime®, Preferenz™, Purafect MA®, Purafect Ox®, Purafect OxP®, Puramax®, Properase®, Effectenz™, FN2®, FN3®, FN4®, Excellase®, Opticlean® and Optimase® (Danisco/DuPont), Axapem™ (Gist-Brocases N.V.), BLAP (sequence shown in FIG. 29 of U.S. Pat. No. 5,352,604) and variants hereof (Henkel AG) and KAP (Bacillus alkalophilus subtilisin) from Kao.

### Amylases:

In an aspect, the preferred other enzyme in an automatic dishwashing detergent composition of the invention is an amylase. Suitable amylases may be an alpha-amylase or a glucoamylase and may be of bacterial or fungal origin. Chemically modified or protein engineered mutants are included. Amylases include, for example, alpha-amylases obtained from Bacillus, e.g., a special strain of Bacillus licheniformis, described in more detail in GB1296839.

Suitable amylases include amylases having SEQ ID NO: 3 in WO95/10603 or variants having 90% sequence identity to SEQ ID NO: 3 thereof. Preferred variants are described in WO94/02597, WO94/18314, WO97/43424 and SEQ ID NO: 4 of WO99/019467, such as variants with substitutions in one or more of the following positions: 15, 23, 105, 106, 124, 128, 133, 154, 156, 178, 179, 181, 188, 190, 197, 201, 202, 207, 208, 209, 211, 243, 264, 304, 305, 391, 408, and 444.

Different suitable amylases include amylases having SEQ ID NO: 6 in WO02/010355 or variants thereof having 90% sequence identity to SEQ ID NO: 6. Preferred variants of SEQ ID NO: 6 are those having a deletion in positions 181 and 182 and a substitution in position 193.

Other amylases which are suitable are hybrid alpha-amylase comprising residues 1-33 of the alpha-amylase derived from B. amyloliquefaciens shown in SEQ ID NO: 6 of WO2006/066594 and residues 36-483 of the B. licheniformis alpha-amylase shown in SEQ ID NO: 4 of WO2006/066594 or variants having 90% sequence identity thereof. Preferred variants of this hybrid alpha-amylase are those having a substitution, a deletion or an insertion in one of more of the following positions: G48, T49, G107, H156, A181, N190, M197, 1201, A209 and Q264. Most preferred variants of the hybrid alpha-amylase comprising residues 1-33 of the alpha-amylase derived from B. amyloliquefaciens shown in SEQ ID NO: 6 of WO2006/066594 and residues 36-483 of SEQ ID NO: 4 are those having the substitutions:
M197T;
H156Y+A181T+N190F+A209V+Q264S; or
G48A+T491+G107A+H156Y+A181T+N190F+1201F+A209V+Q264S.

Further amylases which are suitable are amylases having SEQ ID NO: 6 in WO99/019467 or variants thereof having 90% sequence identity to SEQ ID NO: 6. Preferred variants of SEQ ID NO: 6 are those having a substitution, a deletion or an insertion in one or more of the following positions: R181, G182, H183, G184, N195, 1206, E212, E216 and K269. Particularly preferred amylases are those having deletion in positions R181 and G182, or positions H183 and G184.

Additional amylases which can be used are those having SEQ ID NO: 1, SEQ ID NO: 3, SEQ ID NO: 2 or SEQ ID NO: 7 of WO96/023873 or variants thereof having 90% sequence identity to SEQ ID NO: 1, SEQ ID NO: 2, SEQ ID NO: 3 or SEQ ID NO: 7. Preferred variants of SEQ ID NO: 1, SEQ ID NO: 2, SEQ ID NO: 3 or SEQ ID NO: 7 are those having a substitution, a deletion or an insertion in one or more of the following positions: 140, 181, 182, 183, 184, 195, 206, 212, 243, 260, 269, 304 and 476. More preferred amylase variants are those having a deletion in positions 181 and 182 or positions 183 and 184. Most preferred amylase variants of SEQ ID NO: 1, SEQ ID NO: 2 or SEQ ID NO: 7 are those having a deletion in positions 183 and 184 and a substitution in one or more of positions 140, 195, 206, 243, 260, 304 and 476.

Other amylases which can be used are amylases having SEQ ID NO: 2 of WO08/153815, SEQ ID NO: 10 in WO01/66712 or variants thereof having 90% sequence identity to SEQ ID NO: 2 of WO08/153815 or 90% sequence identity to SEQ ID NO: 10 in WO01/66712. Preferred variants of SEQ ID NO: 10 in WO01/66712 are those having a substitution, a deletion or an insertion in one of more of the following positions: 176, 177, 178, 179, 190, 201, 207, 211 and 264.

Further suitable amylases are amylases having SEQ ID NO: 2 of WO09/061380 or variants having 90% sequence identity to SEQ ID NO: 2 thereof. Preferred variants of SEQ ID NO: 2 are those having a truncation of the C-terminus and/or a substitution, a deletion or an insertion in one of more of the following positions: Q87, Q98, S125, N128, T131, T165, K178, R180, S181, T182, G183, M201, F202, N225, S243, N272, N282, Y305, R309, D319, Q320, Q359, K444 and G475. More preferred variants of SEQ ID NO: 2 are those having the substitution in one of more of the following positions: Q87E,R, Q98R, S125A, N128C, T1311, T1651, K178L, T182G, M201L, F202Y, N225E,R, N272E,R, S243Q,A,E,D, Y305R, R309A, Q320R, Q359E, K444E and G475K and/or deletion in position R180 and/or S181 or of T182 and/or G183. Most preferred amylase variants of SEQ ID NO: 2 are those having the substitutions:
N128C+K178L+T182G+Y305R+G475K;
N128C+K178L+T182G+F202Y+Y305R+D319T+G475K;
S125A+N128C+K178L+T182G+Y305R+G475K; or
S125A+N128C+T1311+T165|+K178L+T182G+Y305R+G475K wherein the variants are C-terminally truncated and optionally further comprises a substitution at position 243 and/or a deletion at position 180 and/or position 181.

Other suitable amylases are the alpha-amylase having SEQ ID NO: 12 in WO01/66712 or a variant having at least 90% sequence identity to SEQ ID NO: 12. Preferred amylase variants are those having a substitution, a deletion or an insertion in one of more of the following positions of SEQ ID NO: 12 in WO01/66712: R28, R118, N174; R181, G182, D183, G184, G186, W189, N195, M202, Y298, N299, K302, S303, N306, R310, N314; R320, H324, E345, Y396, R400, W439, R444, N445, K446, Q449, R458, N471, N484. Particular preferred amylases include variants having a deletion of D183 and G184 and having the substitutions R118K, N195F, R320K and R458K, and a variant additionally having substitutions in one or more position selected from the group: M9, G149, G182, G186, M202, T257, Y295, N299, M323, E345 and A339, most preferred a variant that additionally has substitutions in all these positions.

Other examples are amylase variants such as those described in WO2011/098531, WO2013/001078 and WO2013/001087.

Commercially available amylases are Duramyl™, Termamyl™, Termamyl Ultra™, Fungamyl™, BAN™, Stainzyme™, Stainzyme Plus™, Amplify®, Amplify® Prime, Achieve® Choice, Achieve® Advance, Supramyl™, Natalase™, Liquozyme X and BAN™ (from Novozymes A/S), KEMZYM® AT 9000 Biozym Biotech Trading GmbH Wehlistrasse 27b A-1200 Wien Austria, and Rapidase™ Purastar™/Effectenz™, Powerase, Preferenz S100, Preferenx S110, Preferenz S210, ENZYSIZE®, OPTISIZE HT PLUS®, and PURASTAR OXAM® (Danisco/DuPont) and KAM® (Kao).

### Cellulases:

In one aspect, other enzymes include cellulases. Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum disclosed in U.S. Pat. Nos. 4,435,307, 5,648,263, 5,691,178, 5,776,757 and WO89/09259.

Especially suitable cellulases are the alkaline or neutral cellulases having colour care benefits. Examples of such cellulases are cellulases described in EP0495257, EP0531372, WO96/11262, WO96/29397, WO98/08940. Other examples are cellulase variants such as those described in WO94/07998, EP0531315, U.S. Pat. Nos. 5,457,046, 5,686,593, 5,763,254, WO95/24471, WO98/12307 and PCT/DK98/00299.

Commercially available cellulases include Celluzyme™, and Carezyme™ (Novozymes A/S), Clazinase™, and Puradax HA™ (Genencor International Inc.), and KAC-500(B)™ (Kao Corporation).

In one aspect, other preferred enzymes include microbial-derived endoglucanases exhibiting endo-beta-1,4-glucanase activity (EC3.2.1.4), including a bacterial polypeptide endogenous to a member of the genus Bacillus which has a sequence of at least 90%, 94%, 97% or 99% identity to the amino acid sequence SEQ ID NO:2 in U.S. Pat. No. 7,141,403 and mixtures thereof. Suitable endoglucanases are sold under the tradenames Celluclean® and Whitezyme® (Novozymes).

Pectate lyases, mannanases, DNases: Other preferred enzymes that additionally may be comprised in the composition of the invention include pectate lyases, e.g., one sold under the tradenames Pectawash®, Pectaway®, or Xpect®; and mannanase, e.g., the one sold under the tradenames Mannaway® (Novozymes), and Purabrite® (Danisco/DuPont). Finally, the composition may also comprise a deoxyribonuclease (DNase) that catalyzes the hydrolytic cleavage of phosphodiester linkages in the DNA backbone, thus degrading DNA.

The ADW composition of the invention may also comprise additional ingredients. Such additional ingredients are well-know in the art.

### Form of the Composition

An automatic dishwashing detergent composition of the invention is used for cleaning dishware/tableware, e.g., glass, ceramic, plastic and metal dishware/tableware, and the like, in an automatic dishwasher.

The composition of the invention may be in any suitable form. In one embodiment, the invention relates to a composition, wherein the form of the composition is selected from the group consisting of a regular, compact or concentrated liquid; a gel; a paste; a regular or a compacted powder; a granulated solid; a single unit dose (SUD), a homogenous or a multilayer tablet with two or more layers (same or different phases); a pouch having one or more compartments; a single or a multi-compartment unit dose form; or any combination thereof.

The form of the composition may separate the components physically from each other in compartments such as, e.g., water dissolvable pouches or in different layers of tablets. Thereby negative storage interaction between components can be avoided. Different dissolution profiles of each of the compartments can also give rise to delayed dissolution of selected components in the wash solution.

Pouches can be configured as single or multicompartments. It can be of any form, shape and material which is suitable for hold the composition, e.g., without allowing the release of the composition to release of the composition from the pouch prior to water contact. The pouch may be made from water soluble film which encloses an inner volume. Said inner volume can be divided into compartments of the pouch. Preferred films are polymeric materials preferably polymers which are formed into a film or sheet. Preferred polymers, copolymers or derivates thereof are selected polyacrylates, and water-soluble acrylate copolymers, methyl cellulose, carboxy methyl cellulose, sodium dextrin, ethyl cellulose, hydroxyethyl cellulose, hydroxypropyl methyl cellulose, malto dextrin, poly methacrylates, most preferably polyvinyl alcohol copolymers and, hydroxypropyl methyl cellulose (HPMC). Preferably the level of polymer in the film for example PVA is at least about 60%. Preferred average molecular weight will typically be about 20,000 to about 150,000. Films can also be of blended compositions comprising hydrolytically degradable and water-soluble polymer blends such as polylactide and polyvinyl alcohol (known under the Trade reference M8630 as sold by MonoSol LLC, Indiana, USA) plus plasticisers like glycerol, ethylene glycerol, propylene glycol, sorbitol and mixtures thereof. The pouches can comprise a solid laundry cleaning composition or part components and/or a liquid cleaning composition or part components separated by the water-soluble film. The compartment for liquid components can be different in composition than compartments containing solids (US2009/0011970 A1).

### Examples of Automatic Dishwash Detergent Compositions of the Invention

Specific examples of Automatic Dishwash Detergent Compositions comprising a lipase include the following:
(a) POWDER AUTOMATIC DISHWASHING COMPOSITION

| | |
|---|---|
| Nonionic surfactant | 0.4-2.5% |
| Sodium metasilicate | 0-20% |
| Sodium disilicate | 3-20% |
| Sodium triphosphate | 20-40% |
| Sodium carbonate | 0-20% |
| Sodium perborate | 2-9% |
| Tetraacetyl ethylene diamine (TAED) | 1-4% |
| Sodium sulphate | 5-33% |
| Enzymes (including lipase) | 0.0001-0.1% |

(b) POWDER AUTOMATIC DISHWASHING COMPOSITION

| | |
|---|---|
| Nonionic surfactant | 1-2% |
| Sodium disilicate | 2-30% |
| Sodium carbonate | 10-50% |
| Sodium phosphonate | 0-5% |
| Trisodium citrate dihydrate | 9-30% |
| Nitrilotrisodium acetate (NTA) | 0-20% |
| Sodium perborate monohydrate | 5-10% |
| Tetraacetyl ethylene diamine (TAED) | 1-2% |
| Polyacrylate polymer (e.g. maleic acid/acrylic acid | 6-25% |
| copolymer) | |
| Enzymes (including lipase) | 0.0001-0.1% |
| Perfume | 0.1-0.5% |
| Water | 5-10% |

(c) POWDER AUTOMATIC DISHWASHING COMPOSITION

| | |
|---|---|
| Nonionic surfactant | 0.5-2.0% |
| Sodium disilicate | 25-40% |
| Sodium citrate | 30-55% |
| Sodium carbonate | 0-29% |
| Sodium bicarbonate | 0-20% |
| Sodium perborate monohydrate | 0-15% |
| Tetraacetyl ethylene diamine (TAED) | 0-6% |
| Maleic acid/acrylic acid copolymer | 0-5% |
| Clay | 1-3% |
| Polyamino acids | 0-20% |
| Sodium polyacrylate | 0-8% |
| Enzymes (including lipase) | 0.0001-0.1% |

(d) POWDER AUTOMATIC DISHWASHING COMPOSITION

| | |
|---|---|
| Nonionic surfactant | 1-2% |
| Zeolite MAP | 15-42% |
| Sodium disilicate | 30-34% |
| Sodium citrate | 0-12% |
| Sodium carbonate | 0-20% |
| Sodium perborate monohydrate | 7-15% |
| Tetraacetyl ethylene diamine (TAED) | 0-3% |
| Polymer | 0-4% |
| Maleic acid/acrylic acid copolymer | 0-5% |
| Organic phosphonate | 0-4% |
| Clay | 1-2% |
| Enzymes (including lipase) | 0.0001-0.1% |
| Sodium sulphate | Balance |

(e) POWDER AUTOMATIC DISHWASHING COMPOSITION

| | |
|---|---|
| Nonionic surfactant | 1-7% |
| Sodium disilicate | 18-30% |
| Trisodium citrate | 10-24% |
| Sodium carbonate | 12-20% |
| Monopersulphate (2 KHSO₅•KHSO₄•K₂SO₄) | 15-21% |
| Bleach stabilizer | 0.1-2% |
| Maleic acid/acrylic acid copolymer | 0-6% |
| Diethylene triamine pentaacetate, pentasodium salt | 0-2.5% |
| Enzymes (including lipase) | 0.0001-0.1% |
| Sodium sulphate, water | Balance |

(f) POWDER AND LIQUID DISHWASHING COMPOSITION WITH CLEANING SURFACTANT SYSTEM

| | |
|---|---|
| Nonionic surfactant | 0-1.5% |
| Octadecyl dimethylamine N-oxide dihydrate | 0-5% |
| 80:20 wt. C18/C16 blend of octadecyl dimethylamine | |
| N-oxide dihydrate and hexadecyldimethyl amine | |
| N-oxide dihydrate | 0-4% |
| 70:30 wt. C18/C16 blend of octadecyl bis (hydroxy- | 0-5% |
| ethyl)amine N-oxide anhydrous and hexadecyl bis | |
| (hydroxyethyl)amine N-oxide anhydrous | |
| C₁₃-C₁₅ alkyl ethoxysulfate with an | 3 0-10% |
| average degree of ethoxylation of | |
| C₁₂-C₁₅ alkyl ethoxysulfate with an | 3 0-5% |
| average degree of ethoxylation of | |
| C₁₃-C₁₅ ethoxylated alcohol with an | 12 0-5% |
| average degree of ethoxylation of | |
| A blend of C₁₂-C₁₅ ethoxylated alcohols with an | 9 0-6.5% |
| average degree of ethoxylation of | |
| A blend of C₁₃-C₁₅ ethoxylated alcohols with an | 30 0-4% |
| average degree of ethoxylation of | |
| Sodium disilicate | 0-33% |
| Sodium tripolyphosphate | 0-46% |
| Sodium citrate | 0-28% |
| Citric acid | 0-29% |
| Sodium carbonate | 0-20% |
| Sodium perborate monohydrate | 0-11.5% |
| Tetraacetyl ethylene diamine (TAED) | 0-4% |
| Maleic acid/acrylic acid copolymer | 0-7.5% |
| Sodium sulphate | 0-12.5% |
| Enzymes (including lipase) | 0.0001-0.1% |

(g) NON-AQUEOUS LIQUID AUTOMATIC DISHWASHING COMPOSITION

| | |
|---|---|
| Liquid nonionic surfactant (e.g. alcohol ethoxylates) | 2.0-10.0% |
| Alkali metal silicate | 3.0-15.0% |
| Alkali metal phosphate | 20.0-40.0% |
| Liquid carrier selected from higher glycols, | 25.0-45.0% |
| polyglycols, polyoxides, glycolethers | |
| Stabilizer (e.g. a partial ester of phosphoric acid | 0.5-7.0% |
| and a C₁₆-C₁₈ alkanol) | |
| Foam suppressor (e.g. silicone) | 0-1.5% |
| Enzymes (including lipase) | 0.0001-0.1% |

(h) NON-AQUEOUS LIQUID DISHWASHING COMPOSITION

| | |
|---|---|
| Liquid nonionic surfactant (e.g. alcohol ethoxylates) | 2.0-10.0% |
| Sodium silicate | 3.0-15.0% |
| Alkali metal carbonate | 7.0-20.0% |
| Sodium citrate | 0.0-1.5% |
| Stabilizing system (e.g. mixtures of finely divided | 0.5-7.0% |
| silicone and low molecular weight dialkyl polyglycol | |
| ethers) | |
| Low molecule weight polyacrylate polymer | 5.0-15.0% |
| Clay gel thickener (e.g. bentonite) | 0.0-10.0% |
| Hydroxypropyl cellulose polymer | 0.0-0.6% |
| Enzymes (including lipase) | 0.0001-0.1% |
| Liquid carrier selected from higher lycols, polyglycols, | Balance |
| polyoxides and glycol ethers | |

(i) THIXOTROPIC LIQUID AUTOMATIC DISHWASHING COMPOSITION

| | |
|---|---|
| C₁₂-C₁₄ fatty acid | 0-0.5% |
| Block co-polymer surfactant | 1.5-15.0% |
| Sodium citrate | 0-12% |
| Sodium tripolyphosphate | 0-15% |
| Sodium carbonate | 0-8% |
| Aluminium tristearate | 0-0.1% |
| Sodium cumene sulphonate | 0-1.7% |
| Polyacrylate thickener | 1.32-2.5% |
| Sodium polyacrylate | 2.4-6.0% |
| Boric acid | 0-4.0% |
| Sodium formate | 0-0.45% |
| Calcium formate | 0-0.2% |
| Sodium n-decydiphenyl oxide disulphonate | 0-4.0% |
| Monoethanol amine (MEA) | 0-1.86% |
| Sodium hydroxide (50%) | 1.9-9.3% |
| 1,2-Propanediol | 0-9.4% |
| Enzymes (including lipase) | 0.0001-0.1% |
| Suds suppressor, dye, perfumes, water | Balance |

(j) LIQUID AUTOMATIC DISHWASHING COMPOSITION

| | |
|---|---|
| Alcohol ethoxylate | 0-20% |
| Fatty acid ester sulphonate | 0-30% |
| Sodium dodecyl sulphate | 0-20% |
| Alkyl polyglycoside | 0-21% |
| Oleic acid | 0-10% |
| Sodium disilicate monohydrate | 18-33% |
| Sodium citrate dihydrate | 18-33% |
| Sodium stearate | 0-2.5% |
| Sodium perborate monohydrate | 0-13% |
| Tetraacetyl ethylene diamine (TAED) | 0-8% |
| Maleic acid/acrylic acid copolymer | 4-8% |
| Enzymes (including lipase) | 0.0001-0.1% |

(k) LIQUID AUTOMATIC DISHWASHING COMPOSITION CONTAINING PROTECTED BLEACH PARTICLES

| | |
|---|---|
| Sodium silicate | 5-10% |
| Tetrapotassium pyrophosphate | 15-25% |
| Sodium triphosphate | 0-2% |
| Potassium carbonate | 4-8% |
| Protected bleach particles, e.g. chlorine | 5-10% |
| Polymeric thickener | 0.7-1.5% |
| Potassium hydroxide | 0-2% |
| Enzymes (including lipase) | 0.0001-0.1% |
| Water | Balance |

(l) Automatic dishwashing compositions as described in (a), (b), (c), (d), (f) and (j), wherein perborate is replaced by percarbonate.
(m) Automatic dishwashing compositions as described in (a) to (f) which additionally contain a manganese catalyst. The manganese catalyst may, e.g., be one of the compounds described in “Efficient manganese catalysts for low-temperature bleaching”, Nature 369, 1994, pp. 637-639.
(n) Automatic dishwashing detergent compositions as described in (a) to (k), wherein the lipase is Lipex TLL-A (described in the examples).
(o) Automatic dishwashing detergent compositions as described in (a) to (k), wherein the lipase is a Lipase GCL1-A (described in the examples).

### Method of Cleaning Dishware/Tableware in an Automatic Dishwasher

In a second aspect, the invention relates to a method of cleaning dishware/tableware, and the like, in an automatic dishwasher comprising carrying out a wash cycle comprising a washing step of subjecting the dishware/tableware, and the like, to a wash liquor comprising an ADW composition of the invention. The dishware/tableware, and the like, is subjected to the wash liquor comprising a composition according to the invention during a main wash step. The cleaning method of the invention typically comprises a main wash step and one or more rinse steps. In an embodiment, the cleaning method comprises a pre-rinse step, a main wash step, one or more rinse steps, and optionally a drying step.

In an embodiment, the cleaning method of the invention uses 4-7 L washing liquor for the main wash step and 4-10 L water is used for the one or more rinse steps. The temperature in the main washing step may preferably reach between 40-60 °C, in particular around 45 °C or 55 °C, and the temperature during the rinse step reaches between 50-70 °C. In an embodiment, the main washing step lasts for 20-100 minutes, and rinse step lasts for 20-100 minutes. In a preferred embodiment, the main wash step is carried out at a temperature between 30-70 °C, preferably 40-60 °C, especially around 45 °C or around 55 °C. The automatic dishwashing detergent composition of the invention may be dosed at 1-10 g/L, in particular 2-8 g/l, especially 30 g per 5.4 L wash liquor. According to the invention, the automatic dishwashing detergent composition of the invention is added during the main washing step. In an embodiment, 0.01-10 ppm, preferably 0.05-5 ppm, in particular around 0.2 ppm lipase is present in the wash liquor during the main wash step.

### Uses of an Automatic Dishwashing Detergent Composition (ADW Composition) of the Invention

In this aspect, the present invention relates to the use of the automatic dishwashing detergent composition of the invention for cleaning dishware/tableware, e.g., glass, ceramic, plastic and metal dishware/tableware, and the like, in an automatic dishwasher.

In an embodiment, the invention concerns the use of an automatic dishwashing detergent composition of the invention for cleaning dishware/tableware, e.g., glass, ceramic, plastic and metal dishware/tableware, and the like, in an automatic dishwasher.

### The Invention is Described in the Following Numbered Paragraphs:

1. An automatic dishwashing detergent composition comprising a lipase.
2. The automatic dishwashing detergent composition of paragraph 1, wherein the lipase is the parent lipase shown in SEQ ID NO: 1 or a lipase having at least 60%, at least 65%, at least 70%, at least 75%, at least 80%, at least 85%, at least 90%, at least 95% identity, at least 96%, at least 97%, at least 98%, or at least 99%, or 100% sequence identity to SEQ ID NO: 1.
3. The automatic dishwashing detergent composition of paragraph 1 or 2, wherein the lipase is a variant of SEQ ID NO: 1, wherein the lipase variant has lipase activity, and comprises one or more of the following substitutions corresponding to E1C, T231R, N233R or N233C of SEQ ID NO: 1.
4. The automatic dishwashing detergent composition of any one of paragraphs 1-3, wherein the lipase is a lipase variant comprising substitutions corresponding to T231R+N233R, and optionally at least one or more (e.g., several) of D96E, D111A, D254S, G163K, P256T, G91T and G38A of SEQ ID NO: 1.
5. The automatic dishwashing detergent composition of any one of paragraphs 1-4, wherein the lipase is a lipase variant comprising substitutions corresponding to the substitutions selected from the following set of substitutions in SEQ ID NO: 1:

R231R + N233R;
D96E + T231R + N233R;
N33Q + D96E + T231R + N233R;
N33Q + D111A + T231R + N233R;
N33Q + T231R + N233R + P256T;
N33Q + G38A + G91T + G163K + T231R + N233R + D254S;
N33Q + G38A + G91T + D96E + D111A + G163K + T231R + N233R + D254S + P256T;
D27R + N33Q + G38A + D96E + D111A + G163K + T231R + N233R + D254S + P256T;
D27R + N33Q + G38A + G91T + D96E + D111A + G163K + T231R + N233R + P256T;
D27R + N33Q + G38A + G91T + D96E + D111A + G163K + T231R + N233R + D254S;
D27R + G38A + G91T + D96E + D111A + G163K + T231R + N233R + D254S + P256T;
D96E + T231R + N233R + D254S;
T231R + N233R + D254S + P256T;
G163K + T231R + N233R + D254S;
D27R + N33Q + G38A + G91T + D96E + G163K + T231R + N233R + D254S + P256T;
D27R + G91T + D96E + D111A + G163K + T231R + N233R + D254S + P256T;
D96E + G163K + T231R + N233R + D254S;
D27R + G163K + T231R + N233R + D254S;
D27R + G38A + G91T + D96E + D111A + G163K + T231R + N233R + D254S;
D27R + G38A + G91T + D96E + G163K + T231R + N233R + D254S + P256T;
D27R + G38A + D96E + D111A + G163K + T231R + N233R + D254S + P256T;
D27R + D96E + G163K + T231R + N233R + D254S;
D27R + D96E + D111A + G163K + T231R + N233R + D254S + P256T;
D27R + G38A + D96E + G163K + T231R + N233R + D254S + P256T
D111A + G163K + T231R + N233R + D254S + P256T;
D111A + T231R + N233R;
D111A + T231R + N233R + D254S + P256T;
D27R + D96E + D111A + G163K + T231R + N233R;
D27R + D96E + D111A + T231R + N233R;
D27R + N33Q + G38A + D96E + D111A + T231R + N233R + D254S + P256T;
D27R + G38A + D96E + D111A + G163K + E210Q + T231R + N233R + D254S + P256T;
D27R + T231R + N233R + D254S + P256T;
D96E + D111A + G163K + T231R + N233R;
D96E + D111A + G163K + T231R + N233R + D254S + P256T;
D96E + D111A + G163K + T231R + N233R + P256T;
D96E + D111A + T231R + N233R;
D96E + D111A + T231R + N233R + D254S;
D96E + D111A + T231R + N233R + D254S + P256T
D96E + D111A + T231R + N233R + P256T;
D96E + G163K + T231R + N233R + D254S + P256T;
D96E + T231R + N233R + D254S + P256T;
D96E + T231R + N233R + P256T;
G38A + D96E + D111A + T231R + N233R;
G91T + D96E + D111A + G163K + T231R + N233R + D254S + P256T;
G91T + D96E + D111A + T231R + N233R;
G91T + D96E + T231R + N233R;
G91T + T231R + N233R + D254S + P256T;
N33Q + D96E + D111A + G163K + T231R + N233R + D254S + P256T;
T231R + N233R + D254S + P256T;
T231R + N233R + P256T.

6. The automatic dishwashing detergent composition of any one of paragraphs 1-5, wherein the lipase is a lipase variant, wherein said variant
(a) comprises a modification in at least one position corresponding to positions E1, V2, N33, F51, E56, L69, K98, V176, H198, E210, Y220, L227, and K237 of SEQ ID NO: 1; and optionally further comprises a modification in at least one position corresponding to positions D27, G38, D96, D111, G163, T231, N233, D254, and P256 of SEQ ID NO: 1;
(b) has a sequence identity of at least 60% but less than 100% to SEQ ID NO: 1;
(c) has lipase activity.
7. The automatic dishwashing detergent composition of any one of paragraphs 1-5, wherein the lipase is a variant comprising a modification corresponding to at least one of the following positions of SEQ ID NO: 1: E1, V2, D27, N33, G38, F51, E56, L69, D96, K98, D111, G163, V176, H198, E210, Y220, L227, T231, N233, K237, D254, and P256.
8. The automatic dishwashing detergent composition of any one of paragraphs 1-7, wherein the lipase is a lipase variant comprising at least one modification corresponding to the following modifications of SEQ ID NO: 1: E1C, V2Y, D27R, N33K, N33Q, G38A, F51V, E56K, L69R, D96E, D96L, K981, K98Q, D111A, G163K, V176L, H198S, E210K, Y220F, L227G, T231R, N233R, N233C, K237C, D254S, and P256T.
9. The automatic dishwashing detergent composition of any one of paragraphs 1-8, wherein the lipase is a lipase variant further comprises one of the substitutions corresponding to the substitutions in SEQ ID NO: 1 selected from the group of: S54T, S83T, G91A, A150G, 1255A, and E239C.
10. The automatic dishwashing detergent composition of any one of paragraphs 1-9, wherein the lipase is a variant comprising substitutions corresponding to E1C+N233C, and optionally one or more additional substitutions, wherein numbering is according to SEQ ID NO: 1.
11. The automatic dishwashing detergent composition of any one of paragraphs 1-10, wherein the lipase is a variant comprising substitutions corresponding to the substitutions selected from the following set of substitutions of SEQ ID NO: 1:

E1C + N233C;
E1C + H198L + N233C;
E1C + H198G + N233C;
E1C + L69V + N233C;
E1C + L69T + N233C;
E1C + L69S + N233C;
E1C + L69H + N233C;
E1C + L69F + N233C;
E1C + L69C + N233C;
E1C + H198Y + N233C;
E1C + H198T + N233C;
E1C + H198G + N233C;
E1C + L227F + N233C;
E1C + L227R + N233C;
E1C + E210T + N233C;
E1C + E210N + N233C;
E1C + V176M + N233C;
E1C + K98T + N233C;
E1C + K98E + N233C;
E1C + E56S + N233C;
E1C + E56Q + N233C;
E1C + E56R + N233C;
E1C + F51M + N233C;
E1C + D27R + F51Y + N233C;
E1C + V21 + N233C;
E1C + V2N + N233C;
E1C + V2K + N233C;
E1C + V2A + N233C;
E1C + D96L + N233C;
E1C + L69R + N233C;
E1C + V2Y + N233C;
E1C + N233C + P256T;
E1C + N233C + D254S;
E1C + T231R + N233C;
E1C + H198S + N233C;
E1C + D111A + N233C;
E1C + D96E + N233C;
E1C + G38A + N233C;
E1C + N33Q + N233C;
E1C + N33K + N233C;
E1C + E210A + N233C;
E1C + E210Q + N233C;
E1C + E210R + N233C;
E1C + H198D + N233C;
E1C + K98R + N233C;
E1C + K98V + N233C;
E1C + F51L + N233C;
E1C + F51I + N233C;
E1C + K237C;
E1C + L227G + N233C;
E1C + E210K + N233C;
E1C + V176L + N233C;
E1C + K98Q + N233C;
E1C + E56K + N233C;
E1C + L147S + N233C + D254S;
E1C + Y220F + N233C;
E1C + K981 + N233C;
E1C + D27R + F511 + E56R + K98E + T231R + N233C;
E1C + D27R + F511 + E56R + K98E + T231R + N233C + D254S;
E1C + D27R + G38A + F51L + K98I + D111A + G163S + H198S + Y220F + T231R + N233C + P256T;
E1C + D27R + G38A + F51L + D96E + K98I + D111A + G163K + H198S + Y220F + T231R + N233C +
D254S + P256T;
E1C + D27R + G38R + F51L + D96E + K98I + D111A + G163K + H198S + Y220F + T231R + N233C +
D254S + P256T;
E1C + D27R + F51L + D96| + K98I + D111A + G163K + H198S + Y220F + T231R + N233C + P256T;
E1C + D27R + F51L + D96E + K98I + D111A + G163S + H198S + Y220F + T231R + N233C + P256T;
E1C + D27R + F51L + D96E + K98I + D111A + G163K + H198S + Y220F + T231R + N233C + P256T;
E1C + D27R + G38A + F51I + D96E + K98I + D111A + G163K + H198S + Y220F + T231R + N233C +
D254S + P256T;
E1C + D27R + G38A + F51V + D96E + K98I + D111A + G163K + H198S + Y220F + T231R + N233C +
P256T;
E1C + D27R + F51V + D96E + K98I + D111A + G163K + H198S + Y220F + T231R + N233C + P256T;
E1C + D27R + F51V + D96E + K98I + D111A + G163S + H198S + Y220F + T231R + N233C + D254S +
P256T;
E1C + D27R + F51V + D96| + K98I + D111A + G163K + H198S + Y220F + T231R + N233C + D254S + P256T;
E1C + D27R + F51V + K98I + D111A + G163K + H198S + Y220F + T231R + N233C + D254S + P256T;
E1C + D27R + F51V + D96E + K98I + D111A + G163K + H198S + Y220F + T231R + N233C + D254S +
P256T;
E1C + D27R + G38A + F51V + D96E + K98I + D111A + G163K + H198S + Y220F + T231R + N233C +
D254S + P256T;
E1C + F51V + D96E + K98I + D111A + G163S + H198S + Y220F + T231R + N233C + P256T;
E1C + F51L + D96E + K98I + D111A + G163K + H198S + Y220F + T231R + N233C + D254S + P256T;
E1C + G38A + F51V + D96E + K98I + D111A + G163K + H198S + Y220F + T231R + N233C + P256T;
E1C + F51V + D96E + K98I + D111A + G163K + H198S + Y220F + T231R + N233C + P256T;
E1C + F51V + D96| + K98I + D111A + G163K + H198S + Y220F + T231R + N233C + D254S + P256T;
E1C + F51V + K98I + D111A + G163K + H19S + Y220F + T231R + N233C + D254S + P256T;
E1C + F51I + D96E + K98I + D111A + G163K + H198S + Y220F + T231R + N233C + D254S + P256T;
E1C + D27R + F51L + D96E + K98I + D111A + G163K + H198S + Y220F + T231R + N233C + D254S +
P256T;
E1C + D27R + N33K + G38A + F51V + D96E + K98I + D111A + G163K + H198S + Y220F + T231R + N233C;
E1C + G38R + F51V + D96E + K98I + D111A + G163K + H198S + Y220F + T231R + N233C
+ D254S + P256T;
E1C + F51V + D96E + K98I + D111A + G163K + H198S + Y220F + T231R + N233C + D254S + P256T;
E1C + G38A + F51V + D96E + K98I + D111A + G163K + H198S + Y220F + T231R + N233C + D254S + P256T;
E1C + D27R + G38R + F51V + D96E + K98I + D111A + G163K + H198S + Y220F + T231R + N233C +
D254S + P256T.

12. The automatic dishwashing detergent composition of any one of paragraphs 1-11, wherein the lipase, or lipase variant, is derived from a strain of Thermomyces, in particular Thermomyces lanuginosus (TLL), especially the lipase of SEQ ID NO: 1.
13. The automatic dishwashing detergent composition of any one of paragraphs 1-12, wherein the composition provides increased fat (triglyceride) removal on dishwashed surfaces compared to when no lipase, in particular any one of SEQ ID NO: 1, 2, 3, 4, 5, 6, Lipase TLL-A, Lipase GCL1-WT, Lipase GCL1-A, Lipase GCL1-B, or Lipase GCL1-C, is comprised in the composition.
14. The automatic dishwashing detergent composition of any one of paragraphs 1-13, wherein the lipase variant has at least 60%, at least 65%, at least 70%, at least 75%, at least 80%, at least 85%, at least 90%, at least 95% identity, at least 96%, at least 97%, at least 98%, or at least 99%, but less than 100% sequence identity to SEQ ID NO: 1.
15. The automatic dishwashing detergent composition of paragraph 1, wherein the lipase is the parent lipase shown in SEQ ID NO: 2, 3, 4, 5, and 6, respectively, or a lipase having at least 60%, at least 65%, at least 70%, at least 75%, at least 80%, at least 85%, at least 90%, at least 95% identity, at least 96%, at least 97%, at least 98%, or at least 99%, or 100% sequence identity to SEQ ID NOs: 2, 3, 4, 5, and 6, respectively.
16. The automatic dishwashing detergent composition of paragraph 15, wherein the lipase is a lipase variant comprising one or more substitutions at one or more positions corresponding to positions 396, 397, 398, 408, 409, 166 and 325 of SEQ ID NOs: 2, 3, 4, 5, and 6, respectively.
17. The automatic dishwashing detergent composition of paragraph 15 or 16, wherein the lipase is a lipase variant comprising a substitution corresponding to position 396 and one or more further substitutions corresponding to positions of SEQ ID NOs: 2, 3, 4, 5, and 6, respectively, selected from the group consisting of 397, 398, 408, 409, 166 and 325.
18. The automatic dishwashing detergent composition of any one of paragraphs 15-17, wherein the lipase is a lipase variant, wherein the substitution in position 396 corresponds to a substitution selected from the group consisting of G396E, G396Q, G396R, G396K, G396W, G396S, G396A, G396V, G396M, G396P, G396N, G3961, G396D and G396H using SEQ ID NOs: 2, 3, 4, 5, and 6, respectively, for numbering.
19. The automatic dishwashing detergent composition of any one of paragraphs 15-18, wherein the lipase is a variant comprising a substitution at position 408 corresponding to a substitution selected from the group consisting of 1408R, 1408D, 1408E, 1408Q, 1408M, 1408S, 1408G, 1408A, 1408K, 1408P, 1408L, 1408W, 1408V, W398D, 1408H, 1408Y and 1408F using SEQ ID NOs: 2, 3, 4, 5, and 6, respectively, for numbering.
20. The automatic dishwashing detergent composition of any one of paragraphs 15-19, wherein the lipase is a lipase variant further comprising one or more substitutions corresponding to substitutions selected from the group consisting of S397D, S397N, S397T, S397E, W398P, W398L, W398Y, W398V, W398A, W3981, W398R, W398T, W398K, W398S, W398M, L409R, L409K, L409H, L409N, L409E, L409Q, L409D, L409Y, L409S, G325D, G325K, T166L, T166W and T166G using SEQ ID NOs: 2, 3, 4, 5, and 6, respectively, for numbering.
21. The automatic dishwashing detergent composition of any one of paragraphs 15-20, wherein the lipase is a variant, wherein the variant is selected from the group of variants
   a. Variant of the polypeptide of SEQ ID NOs: 2, 3, 4, 5, and 6, respectively, comprising the substitutions G396E, S397D, W398P, 1408R and L409R;
   b. Variant of the polypeptide of SEQ ID NOs: 2, 3, 4, 5, and 6, respectively, comprising the substitutions T166L, G325D, G396E, W398Y and L409R;
   c. Variant of the polypeptide of SEQ ID NOs: 2, 3, 4, 5, and 6, respectively, comprising the substitutions W398P and 1408E;
   d. Variant of the polypeptide of SEQ ID NOs: 2, 3, 4, 5, and 6, respectively, comprising the substitutions T166L, G325D, G396E and W398Y.
22. The automatic dishwashing detergent composition of any one of paragraphs 15-21, wherein the lipase is a variant having at least 60%, at least 65%, at least 70%, at least 75%, at least 80%, at least 85%, at least 90%, at least 95% identity, at least 96%, at least 97%, at least 98%, or at least 99%, but less than 100% sequence identity to SEQ ID NOs: 2, 3, 4, 5, and 6, respectively.
23. The automatic dishwashing detergent composition of any one of paragraphs 15-22, wherein the composition provides increased fat removal on dish washed surfaces compared to when no lipase, in particular any one of SEQ ID NO: 1, 2, 3, 4, 5, 6, Lipase TLL-A, Lipase GCL1-WT, Lipase GCL1-A, Lipase GCL1-B, or Lipase GCL1-C, is comprised in the composition and/or reduced fatty acid salt residues compared to when a lipase of paragraphs 1-14 is used.
24. The automatic dishwashing detergent composition of any one of paragraphs 15-23, wherein the composition provides reduced odor generation after dishwashing compared to when a lipase of any one of paragraphs 1-14 is used.
25. The automatic dishwashing detergent composition of any one of paragraphs 1-24, wherein the lipase is a lipase variant having from 1-40, 1-30, 1-20, such as 1-12, such as 1-11, such as 1-10, such as 1-9, such as 1-8, such as 1-7, such as 1-6, such as 1-5, such as 1-4, such as 1-3, or such as 1, 2, 3, 4, 5, 6, 7, 8, 9, 10, 11, 12, 13, 14, 15, 16, 17, 18, 19, or 20 mutations, especially substitutions.
26. The automatic dishwashing detergent composition of any one of paragraphs 1-25, wherein the composition comprises one or more components selected from the group of: builders, chelators or chelating agents, bleaching systems, bleach activators, bleach catalysts, polymers, surfactants, enzymes, buffers.
27. The automatic dishwashing detergent composition of any one of paragraphs 1-26, wherein the composition comprises one or more builders selected from the group of zeolites, phosphates, such as diphosphates (pyrophosphates), sodium tripolyphosphate (STPP), alkali metal citrates, carbonates and bicarbonates; and the salts of nitrilotriacetic acid (NTA); methylglycine diacetic acid (MGDA); glutaric diacetic acid (GLDA), polycarboxylates such as polymaleates, polyacetates, polyhydroxyacrylates, polyacrylate/polymaleate and polyacrylate/polymethacrylate copolymers, as well as zeolites; layered silicas and mixtures thereof.
28. The automatic dishwashing detergent composition of any one of paragraphs 1-27, wherein the composition is phosphate-free.
29. The automatic dishwashing detergent composition of any one of paragraphs 1-28, comprising a bleach system, in particular one which comprises hydrogen peroxide (H₂O₂) or a source of hydrogen peroxide such as perborate or percarbonate which may be combined with a peracid-forming bleach activator such as tetraacetylethylenediamine (TAED) or nonanoyloxybenzenesulfonate (NOBS), a bleaching system, e.g., comprising peroxyacids of amide, imide, or sulfone type, or a bleach catalyst, such as 1,4,7-trimethyl-1,4,7-triazacyclononane manganese (MnTACN).
30. The automatic dishwashing detergent composition of any one of paragraphs 1-29, comprising one or more surfactants, in particular a non-ionic surfactant, including fatty alcohol polyglycolether, alcohol ethoxylates (AE or AEO) e.g. the AEO-series such as AEO-7, alcohol propoxylates, in particular propoxylated fatty alcohols (PFA), ethoxylated and propoxylated alcohols, alkoxylated fatty acid alkyl esters, such as ethoxylated and/or propoxylated fatty acid alkyl esters (in particular methyl ester ethoxylates, MEE), alkylpolyglycosides (APG), alkoxylated amines, fatty acid monoethanolamides (FAM), fatty acid diethanolamides (FADA), ethoxylated fatty acid monoethanolamides (EFAM), propoxylated fatty acid monoethanolamides (PFAM), polyhydroxyalkyl fatty acid amides, or N-acyl N-alkyl derivatives of glucosamine (glucamides, GA, or fatty acid glucamides, FAGA), as well as products available under the trade names SPAN and TWEEN, and combinations thereof.
31. The automatic dishwashing detergent composition of any one of paragraphs 1-30, comprising an antiredeposition agent, such as sodium carboxymethylcellulose (CMC), methylcellulose, polyvinylpyrrolidone (PVP), polyvinyl alcohol, and polyethylene glycol (PEG).
32. The automatic dishwashing detergent composition of any one of paragraphs 1-31, wherein the composition further comprises one or more enzymes selected from the group of: proteases, amylases, cellulases, carbohydrases, DNases, pectinases, mannanases, arabinases, galactanases, xylanases, oxidases, e.g., a laccase, and/or a peroxidase.
33. The automatic dishwashing detergent composition of any one of paragraphs 1-32, wherein the composition comprises a buffer, including carbonate and MOPS (3-(N-morpholino)propanesulfonic acid).
34. The automatic dishwashing detergent composition of any one of paragraphs 1-33, wherein the composition is in the form of a solid, powder, granulate, liquid, gel or paste.
35. The automatic dishwashing detergent composition of any one of paragraphs 1-34, wherein the composition is in the form of a regular, compact or concentrated liquid; a gel; a paste; a regular or a compacted powder; a granulated solid; a single unit dose (SUD), a homogenous or a multilayer tablet with two or more layers (same or different phases); a pouch having one or more compartments; a single or a multi-compartment unit dose form; or any combination thereof.
36. The automatic dishwashing detergent composition of any one of paragraphs 1-35, wherein the composition does not contain anionic surfactant.
37. The automatic dishwashing detergent composition of any one of paragraph 1-36, wherein the composition does not contain one or more of sodium lauryl sulfate (SLS), sodium laureth sulfate (SLES) and/or linear alkylbenzene sulfonates (LAS).
38. The automatic dishwashing detergent composition of any one of paragraph 1-36, wherein the composition does not contain a foaming surfactant or only comprises non-foaming or low foaming surfactants.
39. The automatic dishwashing detergent composition of any one of paragraph 1-38, wherein the composition only contains nonionic surfactants, in particular alcohol ethoxylates (AE or AEO).
40. The automatic dishwashing detergent composition of any one of paragraph 1-39, wherein the composition contains nonionic surfactants, in particular alcohol ethoxylates (AE or AEO), but not anionic surfactants.
41. A method of cleaning dishware/tableware in an automatic dishwasher comprising carrying out a wash cycle comprising a washing step of subjecting the dishware/tableware to a wash liquor comprising a composition according to any one of paragraphs 1-40.
42. The method of paragraph 41, wherein the dishware/tableware, and the like, is subjected to the wash liquor comprising a composition according to paragraph 1-40 during a main wash step.
43. The method of cleaning of paragraph 41 or 42, comprising a main wash step and one or more rinse steps.
44. The method of any one or paragraphs 41-43, comprising a pre-rinse step, a main wash step, one or more rinse steps, and a drying step.
45. The method of any one of paragraphs 41-44, wherein 4-7 L washing liquor is used for the main wash step and 4-10 L water is used for the one or more rinse steps.
46. The method of any one of paragraph 41-45, wherein the temperature in the main washing step reaches between 40-60 °C, in particular around 45 °C or 55 °C, and the temperature during the rinse step reaches between 50-70 °C.
47. The method of any one of paragraphs 41-46, wherein the main washing step lasts for 20-100 minutes, and rinse step lasts for 20-100 minutes.
48. The method of any one of paragraphs 41-474, wherein the pH in the washing liquor is between 7-12, preferably 7.5-10.5, such as 8-10.
49. The method of cleaning of any one of paragraphs 41-48, wherein main washing step is carried out at a temperature between 30-70 °C, preferably 40-60 °C, especially around 45 °C or around 55 °C.
50. The method of any one of paragraphs 41-49, wherein the automatic dishwashing detergent composition of any one of paragraphs 1-40 is dosed at 1-10 g/L, in particular 2-8 g/l, especially 30 g per 5.4 L washing liquor.
50. The method of any one of paragraphs 40-49, wherein the automatic dishwashing detergent composition of any one of paragraphs 1-39 is added during the main washing step.
51. The method of any one of paragraphs 40-50, wherein 0.01-10 ppm, preferably 0.05-5 ppm, in particular around 0.2 ppm lipase is present in the washing liquor during the main wash step.
52. Use of an automatic dishwashing detergent composition of any one of paragraphs 1-40 for cleaning dishware/tableware, e.g., glass, ceramic, plastic and metal dishware/tableware, and the like, in an automatic dishwasher.

The invention described and claimed herein is not to be limited in scope by the specific aspects herein disclosed, since these aspects are intended as illustrations of several aspects of the invention. Any equivalent aspects are intended to be within the scope of this invention. Indeed, various modifications of the invention in addition to those shown and described herein will become apparent to those skilled in the art from the foregoing description. Such modifications are also intended to fall within the scope of the appended claims. In the case of conflict, the present disclosure including definitions will control.

### Materials & Methods

Lipase TLL-A: Lipase in SEQ ID NO: 1 with T231R, N233R substitutions.
Lipase GCL1-WT: wild-type lipase shown in SEQ ID NO: 2.
Lipase GCL1-A: Lipase shown in SEQ ID NO: 2 with G396E, S397D, W398P, 1408R and L409R substitutions.
Lipase GCL1-B: Lipase shown in SEQ ID NO: 2 with T166L, G325D, G396E, W398Y and L409R substitutions.
Lipase GCL1-C: Lipase shown in SEQ ID NO: 2 with W398P, 1408E substitutions.
Protease BE: Protease shown in SEQ ID NO: 7.
Alpha-Amylase SP: Alpha-Amylase shown in SEQ ID NO: 8.

ADW ballast soil

| | amount | | g fat | | g fat/ |
|---|---|---|---|---|---|
| | in | % | in | g fat/ | 10 g |
| | ballast | fat | ballast | wash | ballast |
| Cream | 565 | 35 | 197.75 | 1.649 | 0.305 |
| Curd cheese powder | 35 | 1 | 0.35 | 0.003 | 0.001 |
| (kvark) (Dr. Otto | | | | | |
| Suwelack Nachf.) (D) | | | | | |
| Egg white (pasteurized) | 655 | 0 | 0 | 0 | 0 |
| Egg yolk (pasteurized) | 295 | 28.4 | 83.78 | 0.699 | 0.129 |
| Full-cream milk 3.5% | 380 | 3.5 | 13.3 | 0.111 | 0.021 |
| (whole milk) | | | | | |
| Heinz Ketchup | 380 | 0.1 | 0.38 | 0.003 | 0.001 |
| Knorr brown sauce | 100 | 34 | 34 | 0.284 | 0.053 |
| (powder) | | | | | |
| Lard | 380 | 100 | 380 | 3.169 | 0.587 |
| Margarine | 380 | 170 | 266 | 2.219 | 0.411 |
| Mustard | 380 | 6 | 22.8 | 0.190 | 0.035 |
| Oil for deep-frying | 380 | 100 | 380 | 3.169 | 0.587 |
| Potato flour | 130 | 0.3 | 0.39 | 0.003 | 0.001 |
| Rape (seed) oil | 1900 | 100 | 1900 | 15.847 | 2.93 |
| Wheat flour | 35 | 1 | 0.35 | 0.0029 | 0.001 |
| sum | 5995 | | | 27.349 | 5.065 |

Model Detergent GLDA

| | active | content of |
|---|---|---|
| Ingredient name | component | component |
| CitrateNa | 3 | 3 |
| NaFormiate (Formic acid) | 0.2 | 0.2 |
| GLDA (Tetrasodium | 30 | 79 |
| glutamate diacetate) | | |
| HEDP (1- | 0.3 | 0.5 |
| Hydroxyethylidene- | | |
| 1,1-diphosphonic | | |
| acid) | | |
| PCA Copolymer | 1 | 2.5 |
| Water | 65.5 | 14.8 |
| Total | 100 | 100 |

| | |
|---|---|
| In-wash pH | Approx 7.5 |

### EXAMPLES

The present invention is further described by the following examples that should not be construed as limiting the scope of the invention.

### Example 1

### pNP Assay for Determination of Lipase Activity

Enzymes can be assayed for lipase activity using the pNP assay described below.

### Principle

The substrate pNP-substrate is hydrolyzed by the lipase under standard conditions. pNP-valerate is used as an example of a saturated short chain fatty acid. Valeric acid as the acyl group may be replaced by a long chain fatty acid such as oleic acid.

Hydrolysis of the pNP-substrate results in a yellow solution, the absorbance of the solution measured at 405 nm is a function of the activity of the lipolytic enzyme.

By varying the pNP substrate the ratio between lipase activity on unsaturated substrates having long fatty acyl chains (e.g., oleic acid) to short acyl chain (e.g. p-nitrophenyl butyrate and/or p-nitrophenyl valerate) can be determined. Variation of substrate may call for adjustment of e.g. buffer system, adjustments that are easily within the purview of the skilled person.

### Lipase Activity

### Enzymes are Diluted in BUFFER

Substrate: The relevant pNP substrate (e.g. pNp-Valerate Sigma N-4377) 1 mM in Buffer prepared from stock-solution 100 mM in Methanol
Buffer: 50 mM TRIS, 0.4% Triton X-100, is prepared to pH 7.7

| Step | Preparation |
|---|---|
| 1 | Substrate-stock is made to 100 mM in Methanol |
| | 112 mg pNp-Valerate in 5 ml Methanol. |
| | This solution must be kept in a dark bottle or wrapped |
| | in aluminium foil to avoid daylight. |
| | The solution is to be kept at −18 °C |
| | Prepare fresh every 2 weeks |
| 2 | Enzymes are diluted to a concentration corresponding |
| | to Vmax < 70 mAbs/min |
| 3 | Substrate is prepared: |
| | 0.1 ml pNp-Valerate Stock-solution |
| | 9.9 ml Buffer |

| Step | Assay |
|---|---|
| 1 | Samples: Diluted enzyme 20 microL |
| | pNP-substrate 150 microL |
| 2 | Reference: Buffer 20 microL |
| | pNP-substrate 150 microL |
| | Reference must be included in every assay |
| 3 | The measurement is done as a kinetic measurement at 405 nm. |
| 4 | Setup: |
| | Wavelength: 405 nm |
| | Time: 10:00 min. |
| | Interval 10 sec. |

| Step | Preparation |
|---|---|
| | Reads: 61 |
| | Automix: Once |
| | Lag time: 0 |
| | End time: 10:00 |
| | ODmin: 0 |
| | Odmax: 2 |
| 5 | Result: Vmax calculated from measurement points |

### Example 2

Tests of Fatty Acid Salt Redeposition Performance Using Mini Launder-O-Meter (Mini-LOM) at 45 °C in-Wash Temperature

A Mini Launder-O-Meter (Mini LOM) is a medium scale model wash system that can be applied to test up to 24 different wash conditions simultaneously. A LOM is a rotator with free 50 ml×24 tube rotisserie accessory included, with capacity of 10 to 50 mL of detergent solution in each tube. Each tube contains a solution of a specific detergent/enzyme/oil system. Mechanical stress is achieved by a rotating axis which mixes them horizontally or vertically. Ambient temperatures from 4 °C to 55 °C is used, and the rotation range is from 10 to 70 rpm.

Mini LOM scale automatic dish wash fatty acid salt redeposition performance was tested by visually evaluate the deposits on the surface of the tubes and water surface in ADW liquid model detergent GLDA under the experimental conditions given in the Table below.

| Model detergent GLDA dosage | 6.8 | g/L |
|---|---|---|
| Lipase TLL-A dosage | 0 or 1.3 mg enzyme protein/L | |
| Lipase-GCL1-A dosage | 0 or 1.0 mg enzyme protein/L | |
| Water hardness (°dH) | approx. 21°dH | |
| Water hardness ratio: | As is | |
| Water source: | tap water | |
| Wash time (min): | 15 | |
| Wash temperature (°C): | 45 | |
| Intended wash volume (L): | 0.05 | |
| RPM: | 25 | |
| Storage time: | 7 | days |

| | |
|---|---|
| Storage temperature (°C): | 5 |
| Tube: | Polypropylen, Röhre mit verschluß, |
| | Sarstedt AG & Co KG |
| Rape seed oil: | 0 or 50 g/L |

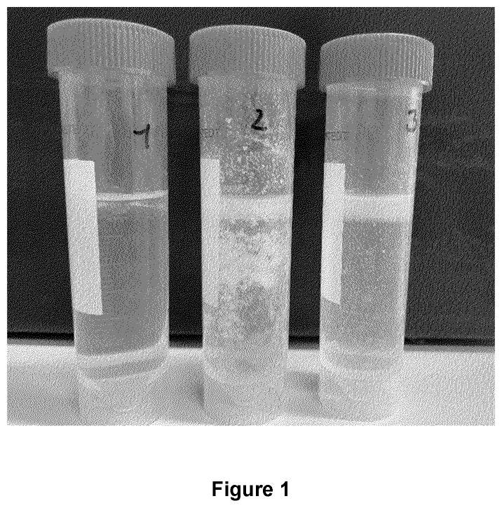

Results: The results of incubating Rapeseed oil with Lipase TLL-A and Lipase GCL1-A, respectively, showed that a large amount of fatty acid salt residues was redeposited on the surface of the tube with added Lipase TLL-A while the tube with added Lipase GCL1-A was clear from any fatty acid salt redeposits as shown in the photo in FIG. 1. Tube 1: Blank, Tube 2: Lipase TLL-A, Tube 3: Lipase GCL1-A.

### Example 3

Dish Wash Performance Using Terg-O-to-Meter (TOM), 45 °C in-Wash Temperature, 20 °C Rinse

The Terg-O-To-Meter (TOM) set-up was as described in Example 3.

The fatty acid salt redeposition was tested on glass coupons in liquid ADW Model Detergent GLDA. After the wash the glass coupons were transferred to another 1 L beaker and rinsed with tap water at 20 °C. The experimental conditions are given in the Table below.

| | |
|---|---|
| Model Detergent GLDA dosage | 6.8 g/L |
| Lipase TLL-A dosage | 0, 1 or 9.7 mg enzyme protein/L |
| Lipase GCL1-A dosage | 0, 3.3 or 16.5 mg enzyme protein/ |
| | L (ppm) |
| Water hardness (°dH) | approx. 21dH |
| Water hardness ratio: | As is |
| Water source: | tap water |
| Wash time (min): | 20 |
| Wash temperature (°C): | 45 |
| Intended wash volume (L): | 1 |
| RPM: | 60 |
| Rinse water hardness (°dH) | approx. 21 |
| Rinse time (min): | 5 |
| Rinse temperature (°C): | 20 |
| Intended rinse volume (L): | 1 |
| Rinse RPM: | 60 |
| Drying | 3 days at room temperature |
| Glass coupons | Watch glass 40 mm Ø Schott |
| ADW ballast soil | 0 or 20 g/L |

Results: The amount of generated fatty acid salt residues was evaluated by washing at 45 °C with Lipase TLL-A, and Lipase GCL1-A, respectively, in ADW ballast soil using the TOM ADW set-up including a 20 °C rinse step.

After rinsing, spots of slimy fatty acid salt residues were seen on glass coupons washed with Lipase TLL-A with ADW ballast soil. The glass coupons washed with Lipase G9L7 looked shinier and had less measurable deposits than the glass coupons washed in detergent alone (Blank) and the glass coupons wash with Lipase TLL-A. Increasing the dosage of Lipase GCL1-A gave even less deposits on the glass coupons showing a dose-response effect while increasing dosage of Lipase TLL-A gave increasing amount of slimy fatty acid salt residues.

| | | Enzyme | Soil amount | |
|---|---|---|---|---|
| | | dosage | on glass | Standard |
| Soil name | Enzyme name | (ppm) | coupons in mg | deviation |
| ADW ballast | Blank | — | 4.9 | 1.13 |
| soil | Lipase TLL-A | 1 | 3.7 | 0.57 |
| | Lipase TLL-A | 9.7 | 9.3 | 5.37 |
| | Lipase GCL1-A | 3.3 | 4.3 | 2.26 |
| | Lipase GCL1-A | 16.5 | 1.1 | 0.00 |

### Example 4

Dish Wash Performance Using Terg-O-to-Meter (TOM), 45 °C in-Wash Temperature, 20 °C Rinse

The Terg-O-To-Meter (TOM) set-up was as described in Example 3.

The fatty acid salt redeposition was tested on glass coupons in liquid ADW Model Detergent GLDA. After the wash the glass coupons were transferred to another 1 L beaker and rinsed with tap water at 20 °C. The experimental conditions are given in the Table below.

| | |
|---|---|
| Model Detergent GLDA dosage | 6.8 g/L |
| Lipase TLL-A dosage | 0, 3.3 or 6.6 mg enzyme protein/L |
| Lipase GCL1-WT, -A, -B, | 0, 3.3 or 6.6 mg enzyme protein/ |
| or -C dosage | L (ppm) |
| Water hardness (°dH) | approx. 21 |
| Water hardness ratio: | As is |
| Water source: | tap water |
| Wash time (min): | 20 |
| Wash temperature (°C): | 45 |
| Intended wash volume (L): | 1 |
| RPM: | 60 |
| Rinse water hardness (°dH) | approx 21 |
| Rinse time (min): | 5 |
| Rinse temperature (°C): | 20 |
| Intended rinse volume (L): | 1 |
| Rinse RPM: | 60 |
| Drying | 3 days at room temperature |
| Glass coupons | Watch glass 40 mm Ø Schott |
| ADW ballast soil | 0 or 20 g/L |

### Results

After rinsing, spots of slimy fatty acid salt residues were seen on glass coupons washed with Lipase TLL-A with ADW ballast soil. The glass coupons washed with any of the Lipase GCL1 lipases looked shinier and had less measurable deposits than the glass coupons washed in detergent alone (Blank) and the glass coupons wash with Lipase TLL-A. Increasing the dosage of Lipase GCL1-A gave even less deposits on the glass coupons showing a dose-response effect.

| | | Enzyme | Soil amount | |
|---|---|---|---|---|
| | | dosage | on glass | Standard |
| Soil name | Enzyme name | (ppm) | coupons in mg | deviation |
| ADW ballast | Blank | — | 2.25 | 2.33 |
| soil | Lipase TLL-A | 3.3 | 4.30 | 0.99 |
| | Lipase TLL-A | 6.6 | 4.85 | 3.75 |
| | Lipase GCL1-WT | 3.3 | 1.65 | 0.35 |
| | Lipase GCL1-B | 3.3 | 2.10 | 0.14 |
| | Lipase GCL1-C | 3.3 | 1.50 | 1.98 |
| | Lipase GCL1-A | 3.3 | 1.95 | 0.92 |
| | Lipase GCL1-A | 6.6 | 0.85 | 0.35 |

### Example 5

Tests for Butanoic Acid (Butyric Acid) Odor Generation Using Lipase-GCL1-A Versus Lipase TLL-A in Mini Launder-O-Meter (Mini-LOM) at 45 °C in-Wash Temperature and Gas Chromatography-Mass Spectrometry (GC-MS)

A Mini Launder-O-Meter (Mini LOM) is a medium scale model wash system that can be applied to test up to 24 different wash conditions simultaneously. A LOM is a rotator with free 50 ml×24 tube rotisserie accessory included, with capacity of 10 to 50 mL of detergent solution in each tube. Each tube contains a solution of a specific detergent/enzyme/oil system. Mechanical stress is achieved by a rotating axis which mixes them horizontally or vertically. Ambient temperatures from 4 °C to 55 °C is used, and the rotation range is from 10 to 70 rpm.

The tubes for the Mini LOM were beside Model detergent GLDA, water and soil loaded with a GC vial containing 3 plastic coupons. After wash the tubes were drained and the GC vials including the plastic coupons were used for GC-MS analysis. The peak area for each component is calculated.

The experimental conditions are given in the Table below.

| | |
|---|---|
| Model detergent GLDA | 6.8 g/L |
| dosage | |
| Lipase TLL-A dosage | 0 or 1.0 mg enzyme protein/L |
| Lipase-GCL1-A dosage | 0 or 1.0 mg enzyme protein/L |
| Water hardness (°dH) | approx. 21 |
| Water hardness ratio: | as is |
| Water source: | tap water |
| Wash time (min): | 15 |
| Wash temperature (°C): | 45 |
| Intended wash volume (L): | 0.03 |
| RPM: | 25 |
| Tube: | Polypropylen, Röhre mit verschluß, |
| | Sarstedt AG & Co KG |
| GC vials (20 mL) + lids | Supplier: VWR (Cat. No. 548-2167) |
| Plastic coupons | Ø40 mm |
| | Polypropylen plastic sheet |
| ADW ballast soil: | 1.5 g/30 mL |
| GC-MS | Agilent 7890 gas chromatograph coupled |
| | to an Agilent 5977 mass spectrometry |
| | GC-MS system |

### Results

The GC measurements of the headspace over the plastic coupons showed a smaller peak area for butanoic acid (butyric acid) for the sample washed with ADW ballast soil and Lipase GCL1-A compared to the sample washed with ADW ballast soil and Lipase-TTL-A.

Butanoic acid

| | Mean peak area | Std Dev |
|---|---|---|
| Lipase TLL-A | 15,902 | 3,776 |
| Lipase-GCL1-A | 6,315 | 4,329 |
| Blank | 163 | 98 |

### Example 6

### Tests of Fatty Acid Salt Redeposition Performance Using Full Scale Automatic Dish Wash at 45° CC In-Wash Temperature

The Miele G4300 SCU full scale automatic dishwash machine was used for testing the wash performance of dishwash detergent compositions comprising Protease BE, Alpha-Amylase SP and Lipase TLL-A and Lipase GCL1-C, respectfully.

The soil used for the experiment was based on IKW soil preparation method (Methods for Ascertaining the Cleaning Performance of Dishwasher Detergents (Part B, updated 2005)) but the soils, excluding egg yolk and tea, were not applied on the plates but instead mixed in one solution. 150 g of this soil mix—corresponding to the amount of soil in a full IKW wash (minus egg yolk and tea)—was added per machine per wash. The egg yolk was applied according to IKW. Tea soil was not included in this experiment.

The machines wash was loaded with ballast dishware, IKW soil mix, IKW egg yolk plates, ADW ballast soil and enzymes and run at the experimental conditions given in the Table below.

| Model detergent GLDA dosage | 6.8 | g/L |
|---|---|---|
| Lipase TLL-A dosage | 0 or 1.0 mg enzyme protein/L | |
| Lipase-GCL1-C dosage | 0 or 1.0 mg enzyme protein/L | |
| Protease BE | 11.1 mg enzyme protein/L | |
| Alpha-Amylase SP | 0.4 mg enzyme protein/L | |
| Water hardness (°dH) | approx. 21 | |
| Water hardness ratio: | As is | |
| Water source: | tap water | |
| Machine type | Miele G4300 SCU | |
| Wash program | Universal 50 °C | |
| Wash temperature (°C): | 50 | |
| ADW ballast soil: | 50 | g/wash |
| IKW soil mix | 150 | g/wash |

| | |
|---|---|
| IKW egg yolk soil | 5 plates |
| Ballast dishware | Porcelain plates: 22 |

The amount of generated fatty acid salt residues on the filter was evaluated by washing at 50° CC with Lipase TLL-A and Lipase GCL1-A, respectively, with IKW soil and ADW ballast soil using a Miele G4300 SCU program Universal 50 °C dishwasher.

The amount of fatty acid salt residues deposited on the machine filters was measured gravimetrically.

### Results

### Machine Filter

| | Enzyme type | Mean (g) | Std Dev |
|---|---|---|---|
| Filter | Blank | 0.341 | 0.121 |
| | Lipase GCL1-C | 1.718 | 0.104 |
| | Lipase TLL-A | 3.687 | 0.849 |

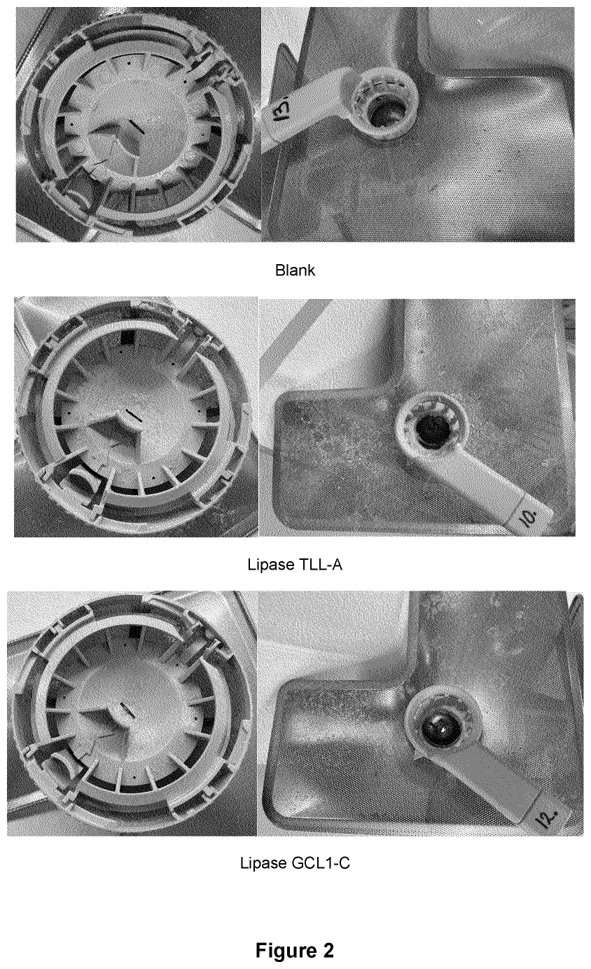

After a full wash program, the dishwasher's filter (see also FIG. 2) had a significantly lower amount of fatty acid salt residues deposited when the wash included Lipase GCL1-C compared to when the wash was done with Lipase TLL-A.

1. An automatic dishwashing detergent composition comprising a lipase, wherein the lipase comprises the amino acid sequence of SEQ ID NO: 2, 3, 4, 5, or 6, or comprises at least 60%, at least 65%, at least 70%, at least 75%, at least 80%, at least 85%, at least 90%, at least 95% identity, at least 96%, at least 97%, at least 98%, or at least 99%, or 100% sequence identity to SEQ ID NOs: 2, 3, 4, 5, or 6.

2. (canceled)

3. The automatic dishwashing detergent composition of claim 1, wherein the composition provides increased fat removal on dishwashed surfaces compared to when no lipase is comprised in the composition.

4. (canceled)

5. The automatic dishwashing detergent composition of claim 1, wherein the composition provides increased fat removal on dish washed surfaces compared to when no lipase is comprised in the composition and/or wherein the composition provides reduced fatty acid salt residues compared to an automatic dishwashing detergent composition comprising a lipase with at least 60% sequence identity to the amino acid sequence of SEQ ID NO: 1.

6. The automatic dishwashing detergent composition of claim 1, wherein the composition provides reduced odor generation after dishwashing compared to an automatic dishwashing detergent composition comprising a lipase with at least 60% sequence identity to the amino acid sequence of SEQ ID NO: 1.

7. The automatic dishwashing detergent composition of claim 1, wherein the composition is in the form of a solid, powder, granulate, liquid, gel or paste.

8. The automatic dishwashing detergent composition of claim 1, wherein the composition does not contain an anionic surfactant.

9. The automatic dishwashing detergent composition of claim 1, wherein the composition does not contain a foaming surfactant.

10. The automatic dishwashing detergent composition of claim 1, wherein the composition only contains non-foaming or low foaming surfactants.

11. A method of cleaning dishware or tableware in an automatic dishwasher comprising carrying out a washing step of subjecting the dishware or tableware to a wash liquor comprising a composition according to claim 1.

12. The method of claim 11, wherein the dishware or tableware, and the like, is subjected to the wash liquor comprising a composition according to claim 1 during a main wash step.

13. (canceled)
